(19) United States
(12) Patent Application Publication
(10) Pub. No.: US 2026/0154337 A1
(43) Pub. Date: Jun. 4, 2026

(54) AI AGENTIC SYSTEMS FOR SCENE UNDERSTANDING

(71) Applicant: NVIDIA Corporation, Santa Clara, CA (US)

(72) Inventor: Rafal WYTRYKUS, Santa Clara, CA (US)

(21) Appl. No.: 19/281,254

(22) Filed: Jul. 25, 2025

Related U.S. Application Data
(60) Provisional application No. 63/676,425, filed on Jul. 28, 2024.

(51) Int. Cl. G06F 16/71; G06F 16/787

(52) U.S. Cl. CPC G06F 16/71; G06F 16/787

(57) ABSTRACT

Embodiments of the present disclosure relate to an AI agentic system for scene understanding. Some embodiments perform such scene understanding by extracting, indexing, and iteratively refining scene data through an AI agent that autonomously generates and refines queries in a continuous loop until a predefined completeness threshold is met. This ensures that scene data is not only captured but also refined over time, producing a fully indexed and queryable representation of the scene.

### CROSS-REFERENCE TO RELATED APPLICATIONS

This application claims the benefit of U.S. Provisional Application No. 63/676,425, entitled “Artificial Intelligence Agentic Systems for Multi-Modal Asset Search, Scene Understanding, and Automated Scene Validation for Synthetically Generated Content,” filed on Jul. 28, 2024, the entirety of which is incorporated herein by reference.

### BACKGROUND

Existing technologies for processing digital content (e.g., rendered 3D scenes) primarily rely on visual techniques that analyze 2D images or 3D visual data to identify objects. For example, these methods may use computer vision algorithms and machine learning models to detect objects and their relative positions. However, they fail to achieve high accuracy because they are inherently limited to visual features and often struggle with challenges such as object occlusion, visual clutter, complex spatial arrangements, and varying viewpoints. As a result, these techniques primarily capture surface-level representations without understanding the contextual or functional relationships between objects and scenes, limiting their ability to comprehensively interpret scenes, especially complex ones.

### SUMMARY

Embodiments of the present disclosure relate to an AI-driven scene understanding system that extracts, indexes, and iteratively refines scene data through an AI agent. The AI agent autonomously generates and refines queries in a continuous loop until a predefined completeness threshold is met. This ensures that scene data is not only captured but also refined over time, producing a fully indexed and queryable representation of the scene.

In some embodiments, the process begins with scene data extraction, where the system extracts objects, spatial properties (e.g., position, orientation, size), visual attributes (e.g., color, texture, shading, reflectivity), physical attributes (e.g., weight, material composition, dimensions, thermal resistance) dynamic data from a real-time data source (e.g., sensor readings from virtual radar or lidar), functional roles (e.g., a lamp as a light source), and/or other attributes from a scene. These extracted elements are then indexed across one or more data structures, including a spatial database (for geometric properties and positioning), a graph database (for semantic relationships and contextual dependencies), and/or a dependency structure (for hierarchical relationships across scenes). By indexing the extracted data, the system enables efficient querying of spatial, functional, and cross-scene relationships, allowing for a more structured and dynamic understanding of the environment.

Once indexed, an AI agent autonomously formulates and issues a series of queries in a continuous loop, refining scene understanding over multiple iterations. This iterative querying process enables the AI agent to detect missing relationships, validate assumptions, and/or refine ambiguous or incomplete data. For example, after detecting that a lamp is near a table, the AI agent may generate follow-up queries to determine whether the lamp illuminates the table, whether shadows are cast, or if obstructions affect visibility. These follow-up queries leverage spatial reasoning (e.g., proximity-based queries), semantic relationships (e.g., illumination dependencies), and/or hierarchical scene references (e.g., whether the lamp configuration changes across different scenes).

The AI agent continues generating queries in a loop until a (e.g., predetermined, pre-defined) threshold of spatial, semantic, and/or dependency-based completeness is reached. This threshold may be defined based on predefined criteria (e.g., ensuring all key spatial relationships have been validated), confidence scores (e.g., detecting that further refinements yield diminishing returns), and/or graph-based consistency checks (e.g., ensuring expected scene dependencies are fully indexed). For example, if the system is being used to analyze a fire extinguisher object in a building layout scene, the AI agent may continue querying until the position, accessibility, and functional dependencies (e.g., relationship with nearby safety signs) of the object is verified.

In some embodiments, once the completeness threshold is met, the system updates the indexed representation of the scene, ensuring that all refined spatial, semantic, and dependency-based relationships are stored for future retrieval. This enables efficient execution of user queries, where scene data can be retrieved without requiring redundant reprocessing.

### BRIEF DESCRIPTION OF THE DRAWINGS

The present systems and methods for sensor simulation and learning sensor models with generative machine learning is described in detail below with reference to the attached drawing figures, wherein:

FIG. 1 is a block diagram illustrating an example scene understanding pipeline, according to some embodiments;

FIG. 2 illustrates an example pipeline that processes and indexes scenes into graph data structures, storing them for querying and retrieval through both general and scene-specific search queries, according to some embodiments;

FIG. 3 is a block diagram illustrating the components of an AI agent, as well as its inputs and outputs, according to some embodiments;

FIG. 4 is a schematic diagram illustrating an example graph data structure that contains graph data, according to some embodiments;

FIG. 5 is a schematic diagram illustrating a quad-tree stored to a spatial database, according to some embodiments

FIG. 6 is a screenshot of an example user interface page illustrating execution of a proximity search, according to some embodiments;

FIG. 7 is a screenshot of an example user interface page illustrating the enforcement of spatial policies, according to some embodiments;

FIG. 8 is a flow diagram illustrating how an AI agent is trained or fine-tuned, according to some embodiments;

FIG. 9 is a flow diagram of an example process for engaging in scene understanding via query looping by an AI agent, according to some embodiments;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Existing technologies often fail to achieve high accuracy in interpreting or understanding scenes (e.g., 3D models, augmented reality spaces, video frames, virtual reality simulations, digital images, digital twins, or any media content). Existing technologies for processing digital scenes primarily rely on visual perception, using 2D images or 3D visual data to identify objects and their spatial arrangements. For instance, these technologies may use convolutional neural networks (CNNs) that detect shapes, colors, and textures to recognize objects. However, they are limited to surface-level visual features, making them incapable of capturing contextual dependencies or functional relationships between objects. This restricts their ability to understand or interpret how objects interact or relate to one another within a scene.

Additionally, visual occlusion and clutter significantly impact the accuracy of existing technologies. When objects overlap or are partially hidden, for example, current technologies fail to identify or misinterpret their spatial relationships. This is compounded by the fact that these models rely on single viewpoints or static renders, which do not account for the dynamic nature of 3D environments. Consequently, these systems struggle with accurately perceiving depth, distance, and object interactions.

Another limitation is the lack of adaptability in current technologies. These systems typically rely on one-shot scene processing, where the scene is analyzed once and cannot be dynamically queried or explored. This rigid approach prevents systems from refining their understanding or resolving ambiguities by issuing follow-up queries. As a result, they are unable to achieve comprehensive scene understanding, especially in complex or evolving environments.

Various embodiments of the present disclosure employ one or more technical solutions that solve one or more of the technical problems described above and other technical problems. Various aspects are directed to using an AI agent for scene understanding. An AI agent autonomously processes information (e.g., generates and answers queries) using artificial intelligence techniques. AI agents can operate using machine learning models (e.g., Large Language Models (LLMs), rule-based systems, and/or natural language processing (NLP), to make decisions, generate outputs (e.g., via text generation), or automate complex tasks. Some embodiments first extract scene data from a scene. For example, some embodiments extract a spatial property of the scene, a visual property of the scene, a natural language semantic label of an object in the scene, and/or an embedding that captures a property of the scene. In an illustrative example, some embodiments extract spatial properties by analyzing the 3D coordinates and geometric properties of objects within the scene via object detection models to identify objects and their bounding boxes, capturing spatial attributes such as position, size, orientation, and distance between objects. In some embodiments, these geometric properties are indexed in a spatial database (e.g., using oct-tree structures) for efficient spatial queries, enabling an AI agent (e.g., a conversational Large Language Model (LLM) agent, such as GPT-index) to calculate proximities, detect collisions, and understand spatial hierarchies, as described in more detail below.

Some embodiments additionally or alternatively extract visual properties such as color, texture, and/or material composition by analyzing the surface appearance of objects. In some embodiments, Vision-Language Models (VLMs) or Convolutional Neural Networks (CNNs) are leveraged to extract visual embeddings from 2D renders or 3D textures. These embeddings are then mapped to descriptive attributes like color names, material types, or texture patterns, which are stored, using an index, as object attributes in the graph database. This allows the AI agent to query visual characteristics and contextually reason about object appearances, as described in more detail below.

Additionally or alternatively, some embodiments extract a natural language semantic label. For example, some embodiments use VLMs that jointly process visual and textual information. These models generate semantic labels by recognizing objects and their contextual roles within the scene (e.g., “sofa” as “furniture” or “lamp” as “light source”). Additionally or alternatively, some embodiments generate an embedding that captures a property of the scene by, for example, converting visual features into a high-dimensional vector representation. This embedding captures contextual and relational information, enabling the AI agent to perform similarity searches, contextual reasoning, and cross-modal queries, as described in more detail below. In some embodiments, both the semantic labels and embeddings are indexed in a graph database(s) for efficient retrieval and contextual reasoning.

In response to extracting the scene data, some embodiments then enable querying of the scene data by indexing the scene data. For example, some embodiments index the scene data into at least one of three structures: a spatial database for geometric properties, a graph database for semantic relationships, or a dependency index for logical and hierarchical dependencies. For example, if the scene contains a lamp, sofa, and rug, the spatial database stores their 3D coordinates, bounding boxes, and spatial relationships (e.g., “Lamp near Sofa” and “Sofa on Rug”) using oct-tree structures for efficient spatial queries. Simultaneously, the graph database represents the objects as nodes and their semantic relationships as edges (e.g., “Lamp illuminates Sofa” and “Sofa is part of Living Room set”). The dependency index captures logical dependencies and nested relationships (e.g., “Lamp references Light Source Asset” and “Sofa is part of Living Room Scene”), as well as dependencies between different scenes (e.g., “living room scene references outdoor scene” or “kitchen scene shares assets with dining room scene”), enabling the system to navigate cross-scene hierarchies and maintain contextual consistency across interconnected digital environments. This multi-database indexing allows the AI agent to efficiently query and navigate the scene by issuing spatial queries to the spatial database, semantic queries to the graph database, and dependency queries to the dependency index, providing enhanced capabilities for dynamic and contextual scene exploration, as described in more detail below.

Based on the extracting of the scene data and the storing of the scene data using the index, some embodiments then automatically and repeatedly generate, via an AI agent (e.g., a reflex agent, a goal-based agent, a utility-based agents, or a learning-based agent), multiple queries (e.g., in a continuous loop) until a threshold of spatial, semantic, and/or dependency-based information associated with the scene is met. In some embodiments, the AI agent initiates or completes a querying loop based on predetermined criteria. For example, the AI agent generates spatial queries to the spatial database for geometric relationships (e.g., proximity, distance), semantic queries to the graph database for contextual dependencies (e.g., illumination, functional roles), and dependency queries to the dependency index for hierarchical relationships in a particular order using one or more rules (e.g., first resolve spatial proximities, then contextual dependencies, and finally hierarchical relationships; or trigger dependency queries only after detecting relevant semantic roles).

Alternatively or additionally, in some embodiments, the AI agent initiates or completes a querying loop based on being prompt engineered, prompt-tuned, or fine-tuned to explore the scene. The AI agent iteratively refines these queries by analyzing intermediate results and identifying gaps in scene understanding. In these embodiments, the AI agent continues to generate queries until a threshold of completeness is reached, ensuring that all relevant spatial, semantic, and/or dependency-based information is fully understood and indexed. In some embodiments, the AI agent identifies gaps in scene understanding by tracking query states and intermediate results using a context manager that maintains a dependency graph of expected spatial, semantic, and/or dependency-based relationships (e.g., where expected relationships are maintained via prompt engineering or tuning). The AI agent compares expected relationships—predicted from prompt templates and/or example input-output pairs—with the retrieved results from previous queries (e.g., via vector-based Euclidian distance, cosine similarity, and/or graph edit distance). When an expected relationship or dependency is missing or incomplete, for example, the context manager flags a gap by detecting unresolved nodes or inconsistent edges in the dependency graph. The AI agent then refines the query prompts by modifying constraints, parameters, and/or query types, generating follow-up queries to resolve the gaps. This iterative querying loop continues until the dependency graph is fully resolved, meeting a threshold of completeness that ensures all relevant spatial, semantic, and/or dependency-based information is detected and indexed. In some embodiments, the threshold is dynamically evaluated by calculating the completeness ratio of resolved dependencies versus expected relationships, ensuring comprehensive scene understanding and context-aware indexing.

In an illustrative example of the AI agent functionality, in a living room scene containing a lamp, sofa, coffee table, and rug objects, the AI agent generates an initial spatial query to detect the proximity relationships between the objects. The AI agent identifies that the lamp is near the sofa. The AI agent then generates a semantic query to determine if the lamp illuminates the sofa, finding no such relationship in the current index. The AI agent identifies this as a gap and issues a follow-up query to explore illumination paths. As the querying loop continues, the AI agent generates dependency queries to check if the lamp references an external light source asset and if any shadows are cast on the rug. The loop iterates until all spatial (e.g., proximity, occlusion), semantic (e.g., illumination), and dependency-based (e.g., asset references) information is detected and indexed, meeting the threshold of completeness. The indexed data is then updated, enabling comprehensive scene understanding and completeness for future runtime querying.

Various embodiments of the present disclosure have various technical effects and benefits relative to existing technologies. For example, some embodiments overcome the limitations of existing technologies, especially accuracy, by using an AI agent that autonomously explores scenes through dynamic query generation and iterative reasoning. Unlike static one-shot methods, the AI agent continuously refines its understanding by generating queries (e.g., spatial, semantic, and/or dependency-based queries) to detect corresponding information in a scene. This approach enables the system to explore emergent relationships and resolve ambiguities through contextual reasoning, achieving a more comprehensive scene understanding.

Some embodiments also address occlusion, visual clutter, or single modality issues by leveraging a multi-data store indexing system that includes a spatial database, graph database, and/or a dependency index, and/or by operating on textual data and not just visual inputs. Unlike existing technologies that rely only on visual data that is prone to occlusion and clutter, some embodiments convert scene information into textual representations, enabling the system to reason about spatial, semantic, and/or dependency-based relationships using natural language queries or prompts. In some embodiments, the spatial database efficiently handles geometric properties and spatial queries such as proximity and containment by indexing textual descriptions of spatial layouts. In some embodiments, the graph database manages semantic relationships and contextual dependencies using natural language labels and functional descriptions. In some embodiments, the dependency index captures hierarchical and logical dependencies in textual form, allowing the AI agent to navigate complex asset structures and maintain scene integrity. By operating on textual data, various embodiments are compatible with text-only foundation models, reducing the need for large-scale visual models and enabling deployment on edge devices, thereby enhancing versatility, accessibility, and explainability in various environments.

Furthermore, various embodiments introduce a dynamic querying loop that allows the AI agent to adapt to changes in the scene in near real-time. Some embodiments monitor the scene continuously, updating the indexed data as new spatial, semantic, and/or dependency-based information is detected. This dynamic adaptability ensures that the system can respond to evolving environments, making it suitable for interactive applications such as virtual reality, robotics, and autonomous navigation, where accurate and adaptive scene understanding is useful.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Digital Asset Retrieval System

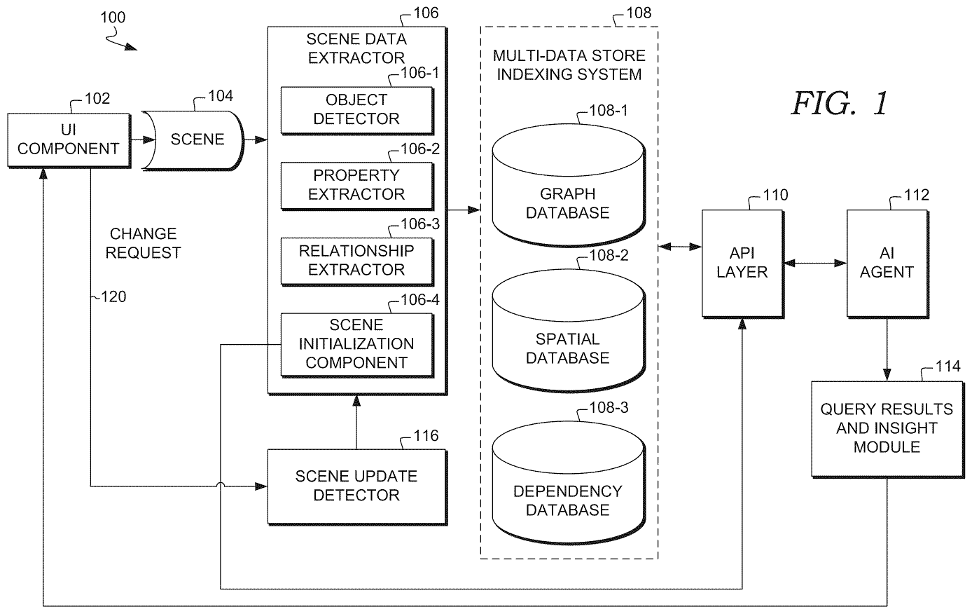

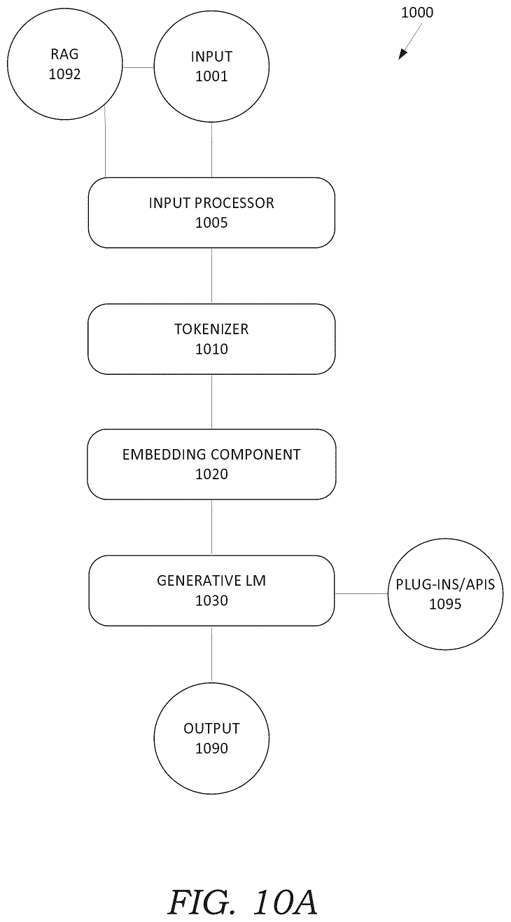

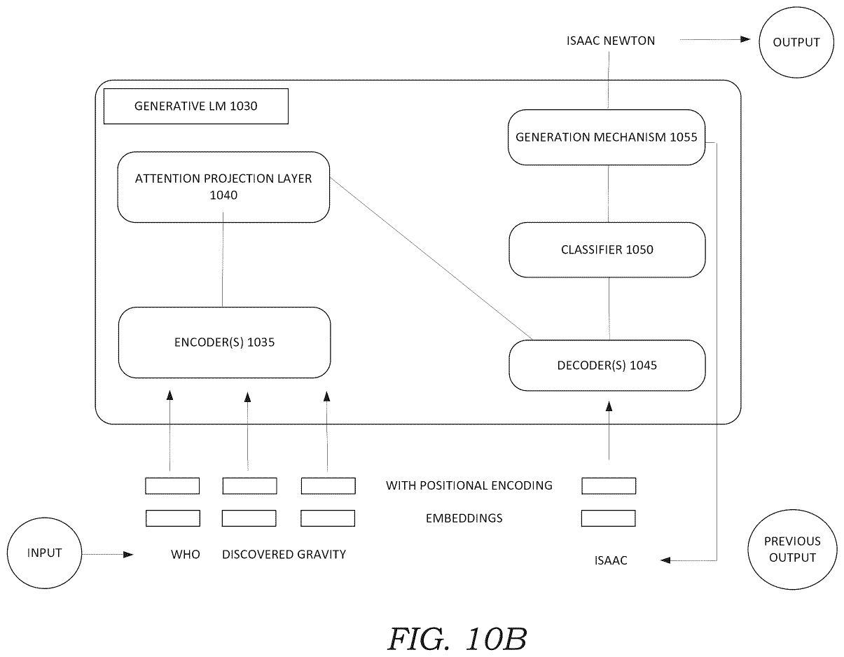

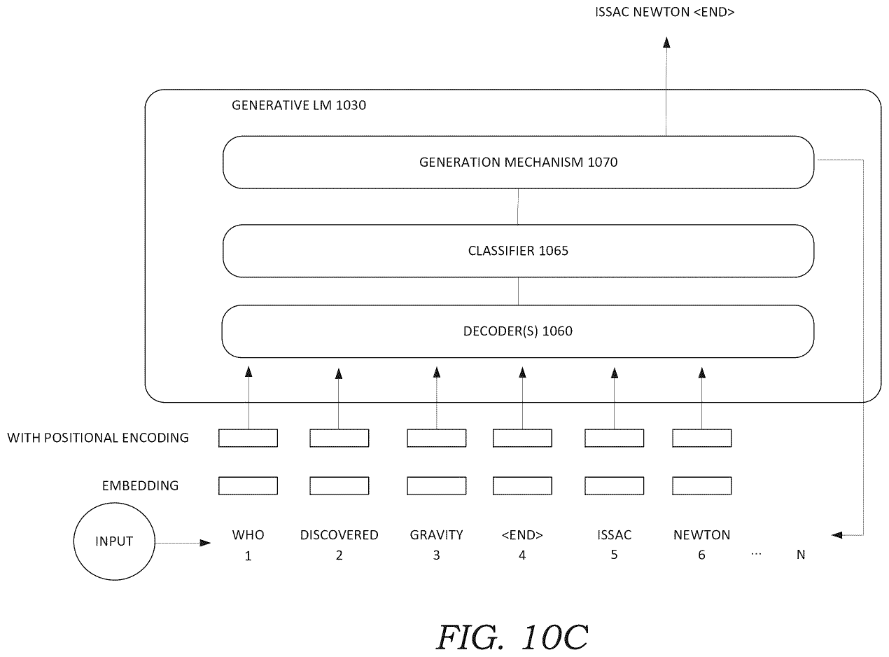

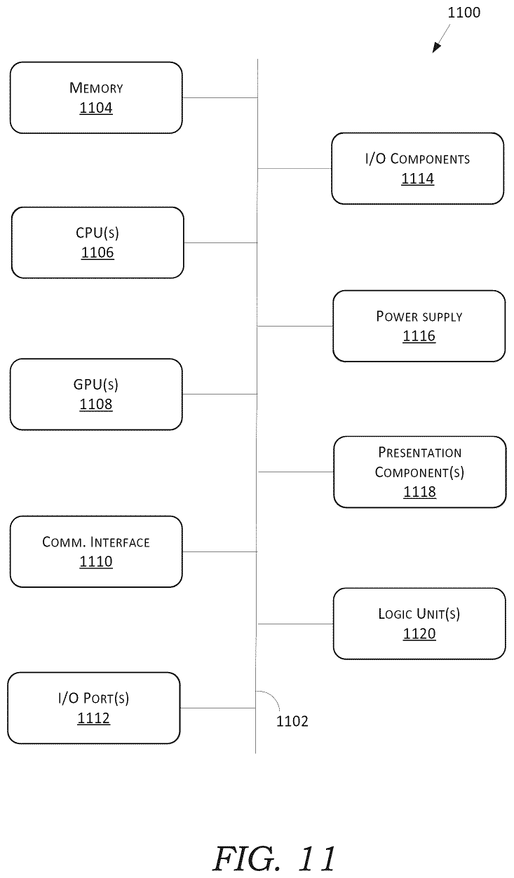

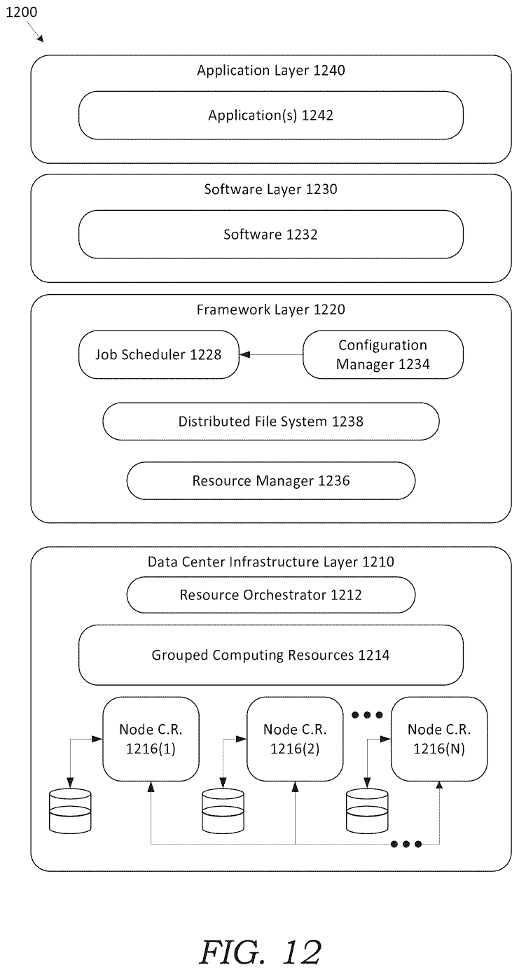

With reference to FIG. 1, FIG. 1 illustrates an example scene understanding pipeline (referred to as “pipeline 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the system and methods described herein (e.g., the AI agent 112 and/or the scene data extractor 106 of FIG. 1) are implemented using one or more generative language models (e.g., as described in FIGS. 10A-10C), one or more computing devices or components thereof (e.g., as described in FIG. 11), and/or one or more data centers or components thereof (e.g., as described in FIG. 12).

As a high level overview, the pipeline 100 is operable to extract various sets of information by generating, via an AI agent 112, a plurality of queries in a continuous loop until a threshold of at least one of spatial, semantic, or dependency-based information associated with the scene is met. The pipeline 100 includes a UI component 102, a scene104, a scene data extractor 106, a multi-data store indexing system 108, an IPI layer 110, an AI agent 112, a query results and insights module 114, and a scene update detector 116.

The UI component 102 is an interface layer that visualizes and allows users to interact with the scene data. For example, a user can upload scenes (e.g., the scene 104), view results and/or suggestions provided by the AI agent 112, manipulate objects in the scene (e.g., move a lamp or add a chair), and/or Issue queries (e.g., “What's near the table?”). The scene 104 is a digital representation (e.g., of a physical environment) composed of objects, spatial arrangements, and contextual relationships, representing a structured space where entities are positioned, interact, or relate to each other. The scene 104 includes geometric properties (e.g., positions, orientations), semantic attributes (e.g., functional roles, contextual labels), and dependencies (e.g., hierarchical or logical relationships), enabling comprehensive spatial and contextual reasoning. The scene 104 is passed from the UI component 102 to the scene data extractor 106 to extract scene data from the scene 104. For example, in response to receiving an indication that a user has uploaded the scene 104 and/or issued a particular query, the UI component 102 returns the scene 104 to the scene data extractor 106 for preprocessing.

The scene data extractor 106 is responsible for preprocessing the scene 106 by extracting spatial, semantic, and/or contextual information. The scene data extractor 106 includes an object detector 106-1, a property extractor 106-2, a relationship extractor 106-3, and a scene initialization component 106-4. The object detector 106-1 detects, identifies, and extracts objects from the scene 104, including their bounding boxes and spatial coordinates. For example, the object detector 106-1 uses object detection models (e.g., You Only Look Once (YOLO) models) to detect entities such as furniture, light sources, or architectural elements using 2D renders or 3D geometry data, converting them into bounding boxes in a universal coordinate system. In some embodiments, the object detector 106- utilizes oct-tree structures for efficient spatial indexing, enabling queries related to object locations, proximity, and approximate collisions. In some embodiments, the output of the object detector 106 is object nodes with bounding boxes, spatial coordinates, and object categories.

An “oct-tree” structure is a hierarchical spatial partitioning data structure that recursively divides a 3D space into eight octants, enabling efficient spatial indexing and querying. The object detector 106-1 in some embodiments uses oct-trees to organize object bounding boxes based on their 3D coordinates, storing objects in the smallest octants that fully contain them. This allows the AI agent 112 to efficiently query object locations by narrowing down search spaces to relevant octants. Proximity queries are performed by checking neighboring octants, ensuring accurate distance calculations. For approximate collisions, the system checks for bounding box intersections within the same or neighboring octants, quickly identifying potential collisions without exhaustive pairwise comparisons. This spatial indexing significantly reduces computational complexity, enabling real-time scene exploration.

In some embodiments, the object detector 106-1 parses a Universal Scene Description (USD) data format, which represents the scene as a hierarchical structure of elements with spatial attributes such as positions, orientations, and parent-child relationships. The object detector 106-1 extracts the spatial data and converts the spatial data into 3D coordinate vectors, organizing them using oct-tree structures for efficient spatial indexing. In some embodiments, the relationship extractor 106-3 analyzes the hierarchical relationships (e.g., “Lamp is part of Living Room Set”) and spatial dependencies (e.g., “Lamp on Table” or “Chair under Table”) from the USD's scene graph structure. The object detector 106-1 then constructs a graph data structure where objects are represented as nodes and their relationships as directed edges. This graph is included as graph data and is indexed, via the multi-data store indexing system 108 in the graph database 108-1, enabling the AI agent to perform semantic and contextual queries.

The property extractor 106-2 extracts visual (e.g., material), spatial, and/or contextual properties of the objects. The property extractor 106-2 captures attributes such as dimensions, color, material, user-assigned properties, and embedding representations of renders. For example, in some embodiments the property extractor 106-2 extracts dimensions from the bounding boxes (e.g., height, width, depth), uses Vision-Language Models (VLMs) to generate embedding representations that capture contextual descriptions of the scene, and/or extracts user-assigned properties (e.g., labels like “fragile” or “heavy”) from scene metadata. The output of the property extractor 106-2 is property attributes linked to each object node, including dimensions, visual properties, semantic labels, and embeddings.

The property extractor 106-2 can extract scene data in any suitable manner. For example, in some embodiments a Vision-Language Model (VLM) processes the scene 104 by jointly encoding visual and textual information to generate metadata that enhances scene understanding. The property extractor 106-2 uses a dual-stream architecture, where the visual stream encodes image features (e.g., object shapes, textures, lighting) using a Convolutional Neural Network (CNN) or Vision Transformer (ViT), while the language stream encodes textual descriptions using a Transformer-based language model. The VLM aligns the visual and textual embeddings through a cross-modal attention mechanism, allowing the VLM to generate context-aware metadata such as material properties, object types, scene context, positioning, and lighting information. This metadata is then included as the scene data and indexed, via the indexing system 108, for efficient querying and contextual reasoning, enabling the AI agent 112 to perform semantic queries and context-aware scene exploration.

In another example and embodiments, the property extractor 106-2 (and/or the relationship extractor 106-3) converts a Universal Scene Descriptor (USD) file into image previews by using a USD renderer that generates 2D renders from various camera angles and lighting conditions, preserving the spatial configurations and material properties of the scene. These image previews are then processed by a VLM or pretrained Convolutional Neural Network (CNN), which encodes the visual features into high-dimensional embeddings. These embeddings capture the contextual and relational properties of the scene, including texture, color, object types, and spatial arrangements, enabling semantic reasoning and cross-modal queries. The embeddings are then indexed, via the indexing system 108, in the graph database 108-1, supporting efficient semantic and contextual queries.

In some embodiments, the property extractor 106-2 computes a multimodal embedding by leveraging a CLIP (Contrastive Language-Image Pre-training) model, which jointly processes text and image data into a shared embedding space. Property extractor 106-2 takes the image of the scene 104 and passes the image through a Vision Transformer (ViT) to extract visual features as a high-dimensional vector. Simultaneously, a text transformer is used to encode textual descriptions (e.g., object labels, scene context, user queries) into a text embedding. The CLIP model then aligns the visual and text embeddings using a contrastive loss function, mapping them into a shared multimodal embedding space where semantically related images and text are positioned closer together. This multimodal embedding captures both visual properties and semantic context, enabling cross-modal reasoning and semantic queries. The embedding is then indexed, via the indexing system 108, in the graph database 108-1 for efficient retrieval and contextual exploration.

In some embodiments, the property extractor 106 uses a combination of models and functions, including ray tracing algorithms, path tracing for realistic lighting simulations, rasterization for real-time rendering, and/or physically-based rendering (PBR) models to simulate materials accurately to extract material properties. For example, the property extractor 106 leverages illumination models (e.g., Phong or Blinn-Phong) to determine how light interacts with surfaces, and global illumination techniques to simulate light bouncing across objects.

The relationship extractor 106-3 identifies spatial and semantic relationships between objects within the scene. The relationship extractor 106-3 captures inferred relationships such as proximity, containment, illumination, functional roles, and contextual dependencies. In some embodiments, relationship extractor 106-3 analyzes spatial arrangements using bounding boxes and oct-tree structures to infer proximity and containment. The relationship extractor 106-3 detects functional dependencies using semantic analysis (e.g., “Lamp illuminates Sofa”) and represents them as directed edges in a graph structure in some embodiments. In some embodiments, the relationship extractor utilizes AI-generated descriptions to extract contextual dependencies (e.g., hierarchical groupings like “Sofa is part of Living Room set”). In some embodiments, the output of the relationship extractor 106-3 includes relationship edges connecting object nodes with spatial, functional, and contextual dependencies, represented in the graph database 108-1 and/or the spatial database 108-2.

Accordingly, the relationship extractor 106-3 first calculates spatial relationships using 3D coordinate vectors and oct-tree indexing. The relationship extractor 106-3 stores these geometric relationships in the spatial database 108-2 for efficient spatial queries (e.g., proximity, containment, and occlusion). Contextual and functional dependencies (e.g., “Lamp illuminates Sofa”) are stored as directed edges in the graph database 108-1. For example, in a scene with a lamp, sofa, and rug, the relationship extractor 106-3 calculates “Lamp near Sofa” using proximity calculations and stores this spatial relationship in the spatial database 108-2. The relationship extractor 106-3 infers “Lamp illuminates Sofa” using semantic embeddings and stores this contextual relationship in the graph database 108-1. This dual-storage approach enables the AI agent 110 to perform both spatial queries (e.g., “What is near the lamp?”) and semantic queries (e.g., “What does the lamp illuminate?”) efficiently.

The scene initialization component 106-4 is generally responsible for generating or packaging information (e.g., from the object detector 106-1, the property extractor 106-2, and/or the relationship extractor 106-3) as scene understanding initialization metadata in a standardized format (e.g., JSON) and provides the metadata to the AI agent 112 through the API layer 110. In this way, the AI agent 112 has a baseline reference or summary of what information the scene 104 contains so that the AI agent 112 can generate at least its first query. For example, the scene initialization component 106-4 passes a high-level summary of the scene 104 to the AI agent 112 that includes: a list of objects detected: names and categories of objects (e.g., “Lamp,” “Sofa,” “Rug”), basic contextual roles: general functional roles (e.g., “Lamp is a light source,” “Sofa is furniture”), scene context overview: the scene name or type (e.g., “Living Room Scene”). However, such summary, for example, does not include detailed spatial relationships (e.g., “Lamp near Sofa”) or contextual dependencies (e.g., “Lamp illuminates Sofa”). The scene initialization component 106-4 does not reveal the underlying database structures or detailed scene indexing. Using the scene understanding initialization metadata, the AI agent 112: knows what objects are present in the scene 104 (e.g., “Lamp,” “Sofa,” “Rug”), identifies relevant query types based on the basic contextual roles (e.g., “Lamp is a light source” suggests querying illumination paths), and/or forms the very first queries using prompt templates related to the detected objects, The AI agent then initiates the querying loop by generating absolute queries to the multi-data store indexing system 108, as described in more detail below.

After the scene data extractor 106 extracts scene data via the object detector 106-1, the property extractor 106-2, and/or the relationship extractor 106-3, the extracted data is passed to the multi-data store indexing system 108, which stores the extracted data using one or more indexes via the graph database 108-1, the spatial database 108-2, and/or the dependency database 108-3. In some embodiments, the multi-data store indexing system 108 uses a data classification engine that categorizes the extracted data based on its type and relational context, determining the appropriate database for storage. In some embodiments, the data is classified as: geometric properties (e.g., positions, orientations, and bounding boxes) as spatial data and stores them in the spatial database 108-2 using oct-tree structures for efficient proximity, containment, and collision queries. In some embodiments, the indexing system 108 classifies the data as contextual dependencies and functional roles (e.g., illumination, object interactions) as semantic data and stores them in the graph database 108-1 using nodes (objects) and edges (relationships). In some embodiments, the indexing system 108 classifies the data as hierarchical relationships and cross-scene dependencies (e.g., parent-child hierarchies, external references) as dependency data and stores them in the dependency index 108-3 using directed graphs for cross-scene navigation and dependency resolution. In some embodiments, the data classification engine is rule-based and context-aware, ensuring that each extracted data type is stored in the appropriate database for efficient querying and contextual reasoning.

The graph database 108-1 stores semantic relationships and contextual dependencies between objects as nodes (representing objects) and edges (representing relationships). The graph database 108-1 enables context-aware reasoning and semantic queries such as functional roles (e.g., “Lamp illuminates Sofa”) and contextual groupings (e.g., “Sofa is part of Living Room Set”). The relationship extractor 106-3, for example, analyzes semantic embeddings and identifies functional dependencies between objects. For instance, when the relationship extractor 106-3 detects that a lamp is near a sofa, a functional relationship is inferred as “Lamp illuminates Sofa” based on semantic context and scene configuration, and the indexing system 108 responsively stores this relationship as a directed edge in the graph database 108-1. This allows the AI agent 112 to contextually query illumination paths and functional roles.

The spatial database 108-2 stores geometric properties and spatial relationships of objects (e.g., using oct-tree structures) for efficient spatial queries such as proximity, containment, occlusion, and collision detection. The spatial database 108-2 indexes 3D coordinates, bounding boxes, and/or spatial hierarchies, enabling the AI agent 112 to efficiently navigate the 3D space and perform geometric reasoning. For example, the object detector 106-1 contributes to the spatial database 108-2 by extracting spatial properties such as positions, orientations, and dimensions of objects from USD files. For instance, when the object detector 106-1 identifies a lamp, sofa, and rug, the object detector 106-1 calculates their 3D positions and bounding boxes, and the indexing system 108 responsively stores them in the spatial database 108-2. This enables the AI agent 112 to perform spatial queries like “What objects are near the Lamp?” or “Is the Sofa on the Rug?”

The dependency index 108-3 captures logical and hierarchical dependencies between scene entities, including parent-child relationships, cross-scene references, and/or external asset dependencies. The dependency index 108-3 enables hierarchical navigation and dependency-based queries, allowing the AI agent 112 to navigate complex structures and maintain scene integrity. The property extractor 106-2, for example, tracks external references and property inheritance. For example, if the property extractor 106-2 detects that a sofa references a fabric material asset, the indexing system 108 stores this external reference in the dependency index 108-3, capturing the logical dependency between the sofa and the material asset. This enables the AI agent 112 to query cross-scene dependencies like “Which objects share this material asset?” or “What scenes reference this asset?” ensuring consistent asset management across interconnected scenes.

The API Layer 110 is an intermediary (e.g., software) layer that exposes standardized interfaces for communication and data exchange between different components of the system, such as the AI agent 112 and the multi-data store indexing system 108. In some embodiments, API Layer 110 provides RESTful or GraphQL endpoints that allow the AI agent 112 to issue queries, retrieve scene data, and update indexed information without needing to understand the underlying database structures of the indexing system 108. The API Layer 110 ensures modularity, scalability, and secure access, enabling the system to be easily extended or integrated with other applications or services.

In an illustrative example, when the AI agent 112 generates a spatial query to find objects near a lamp, the AI agent 112 sends a GET request to the API Layer 110, specifying the query type (e.g., proximity) and target object (lamp). The API Layer 110 translates this request into a spatial query compatible with and associated to the spatial database 108-2 and retrieves the relevant information (e.g., “Sofa near Lamp”). AI agent 112 then formats the response (e.g., in JSON) and returns the response to the AI agent 110, which uses the result to refine its understanding of the scene 104. This modular approach allows the AI agent 112 to dynamically query different databases without needing direct access or knowledge of their internal structures, maintaining system security and scalability.

The AI agent 112 is an autonomous reasoning engine that dynamically generates queries, refines prompts, and iteratively explores scene data of the scene 104 to achieve comprehensive scene understanding. In some embodiments, AI agent 112 uses prompt engineering, prompt-tuning, or fine-tuning to construct natural language queries and operates in a continuous querying loop, generating spatial, semantic, and/or dependency-based queries. In some embodiments, it employs a context manager that tracks query states and intermediate results, identifying gaps in scene understanding and refining queries until a threshold of completeness is reached. The AI agent 112 integrates a query execution engine to retrieve information from the spatial database 108-2, the graph database 108-1, and the dependency index 108-3, enabling context-aware reasoning and dynamic scene exploration. The AI agent 112 is designed to function autonomously without human input, making decisions on-the-fly to detect relationships and update indexed data.

In an illustrative example, in a digital living room scene containing a lamp, sofa, and rug, the AI agent 112 begins by generating a spatial query to determine “What is near the Lamp?” The AI agent 112 uses the query execution engine to retrieve spatial data from the spatial database 108-2, identifying the sofa as being near the lamp. The AI agent 112 then generates a semantic query to explore the functional relationship between the lamp and sofa, querying “Does the Lamp illuminate the Sofa?” If no illumination relationship is found, the context manager identifies this as a gap and prompts the agent 112 to refine the query by exploring illumination paths. This iterative querying continues, generating follow-up queries until the threshold of completeness is reached, ensuring that all relevant spatial, semantic, and dependency-based information is fully detected and indexed. The agent 112 then updates the graph database 108-1 with the newly detected relationship “lamp illuminates Sofa,” enabling efficient future queries and achieving context-aware scene understanding.

The query results and insights module 114 is generally responsible for processing and formatting the results generated by the AI agent 112 and passes this information back to the UI component 102 so that the results can be presented to the user in the UI. For example, the query results and insights module 114 can cause presentation of a list of objects in the scene 104, highlighted relationships (e.g., “The lamp is illuminating the sofa”), and/or suggestions for further exploration. In an illustrative example, in a living room scene containing a lamp and sofa, the query results and insights module 114 receives the query result “Lamp illuminates Sofa” from the AI agent 112. The AI agent 112 formats this relationship into a natural language insight (e.g., “The Lamp is illuminating the Sofa”) and highlights the illumination path visually in the UI. The AI agent 112 also suggests further exploration by presenting a query option like “What other objects are illuminated by the Lamp?” If the user interacts with this suggestion, the feedback is sent to the AI agent 112, triggering a refinement loop for deeper scene exploration.

The scene update detector 116 is a monitoring module that tracks changes in the scene 104 and triggers updates to the indexed data, ensuring real-time adaptability. The scene update detector 116 continuously listens for scene modifications via the change request 120, such as object movements, additions, deletions, or property changes, and compares (e.g., via vector difference calculations, Euclidean distance for spatial changes, graph diff algorithms for relational changes, or hash checksums for property updates) the current scene state with the previously indexed state. When a change over a threshold is detected, the scene update detector 116 identifies the affected spatial, semantic, or dependency-based relationships and updates the relevant indexes in the spatial database 108-2, graph database 108-1, or dependency index 108-3. For example, if a lamp is moved closer to a sofa, the scene update detector 16 recognizes the change in proximity, updates the spatial database 108-2 with the new position coordinates, and automatically triggers the AI agent 112 to re-evaluate illumination paths, ensuring the indexed scene data remains contextually accurate and up-to-date.

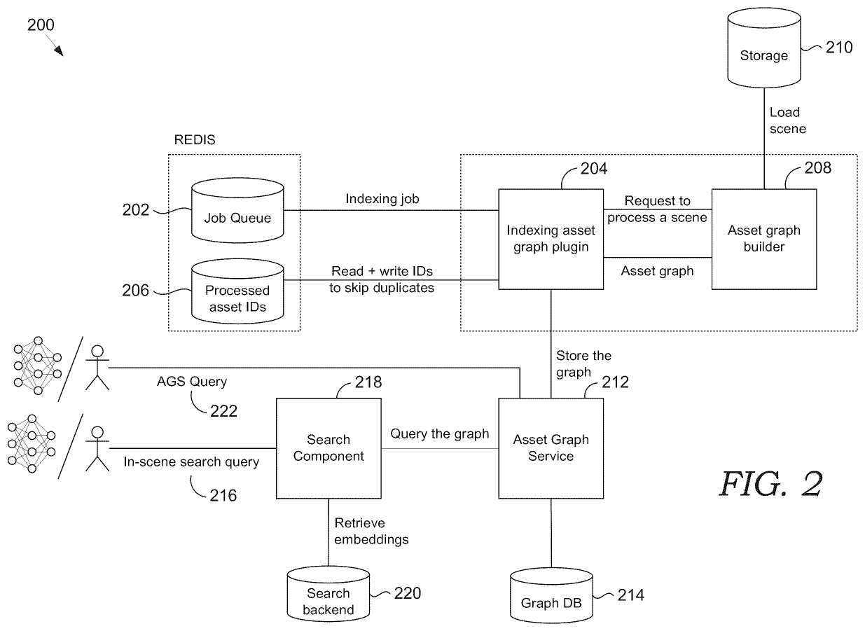

FIG. 2 illustrates an example pipeline 200 that processes and indexes scenes into graph data structures, storing them for querying and retrieval through both general and scene-specific search queries, according to some embodiments. The job queue 202 holds or stores indexing tasks (scenes or assets that need to be processed) and forwards them as indexing jobs to the indexing asset graph plugin 204. In other words, the job queue 202 receives tasks to process and index scenes. Responsively, the indexing asset graph plugin 204 sends a request to the asset graph builder 208 to process the scene and generate an asset graph by using a loaded scene as input from storage 210. For example, the asset graph builder 208 starts by loading the scene data (e.g., a 3D model or environment) from storage 210 (such as AWS S3 or Nucleus). This scene could be a USD file that includes multiple objects with properties like geometry, materials, and textures. The asset graph builder 208 decomposes the loaded scene into individual elements or “prims” (primitives), which represent the objects within the scene (e.g., tables, chairs, lights). At least one (e.g., each) prim may have specific attributes, such as its size, position, material, and relationship to other objects. The builder 208 organizes these elements into a graph data structure, where nodes represent individual objects or entities within the scene (e.g., a chair or a table) and edges represent the relationships between objects (e.g., a chair is placed next to a table, or a lamp is above the table). The graph data structure reflects both hierarchical relationships (e.g., the lamp is a child of the table in the scene hierarchy) and spatial relationships (e.g., the chair is 1 meter away from the table). These relationships are useful for understanding the scene's structure and positioning of objects.

After processing the scene into an asset graph, the asset graph builder 208 sends the constructed graph to the indexing asset graph plugin 204, which forwards the graph to the asset graph service 212 for storage in the graph database 214 (Graph DB) (e.g., the graph database 108-1). This graph can later be queried to retrieve information about the spatial, hierarchical, and material properties of the objects in the scene. Simultaneously or in parallel, the indexing asset graph plugin 204 tracks already-processed scenes (e.g., via logging) to prevent duplicates. The inputs are asset IDs from successfully indexed assets derived from the indexing asset graph plugin 204. For the output, the indexing asset graph plugin 204 reads from this to ensure that duplicate assets are skipped in future jobs.

At search or query time, a human user and/or an AI agent (e.g., AI agent 112) can submit an Asset Graph Service (AGS) query 222, which gets forwarded to the asset graph service 212, which responsively retrieves, from the graph database 214, one or more relevant graph data structures dependent on the AGS query 222. Processing the AGS query 222 using the asset graph service 212 involves looking up relationships, properties, or metadata about assets stored in the Graph DB 214 and/or the dependency database 108-3, such as relationships between scenes (e.g., digital assets). These operate on a higher level of abstraction relative to the in-scene search query 216, such as general asset details from the asset graph service 212, which could be queried by human users or external systems (e.g., AI agent 112) needing information about stored assets. For example, the ASG query 222 may be “all chairs within 2 meters of any table in the current scene(s).” The AGS query 222 is sent to the asset graph service 212, to search for relationships between chairs and tables based on spatial proximity. The asset graph service 212 queries the graph database 214 (which contains the asset graph) to locate nodes (chairs and tables) and analyze the edges (which represent the spatial relationships). The system looks for any chair node that has an edge (spatial relationship) to a table node where the distance is less than or equal to 2 meters. The result would be a list of chairs in the scene(s) that meet this condition, possibly returned with details such as asset IDs or positions.

The “in-scene search query” 216 focuses on searching within a specific scene, typically based on asset properties like color, type, material, and/or metadata. The “in-scene search query” 216 is more localized to the current scene and its content, without necessarily leveraging complex graph relationships.

This query 216 typically focuses on retrieving assets based on simple properties (e.g., object type, color, material) in the current scene. The search component 218 receives the in-scene search query 216, retrieves one or more relevant embeddings from the search backend 220 and/or queries the asset graph service 212 to derive the appropriate graph data structures dependent on the query.

For example, the in-scene search query 216 may be “red chairs for this living room scene.” The search backend 218 stores precomputed embeddings (vector representations, such as multimodal embeddings) of the digital assets (e.g., objects) in the scene. These embeddings were generated during the indexing process by an embedding service (e.g., the indexing system 108 of FIG. 1) and contain detailed information about each asset's visual, textual, and material properties. Using the illustration above, the search component 218 sends a request to the search backend 220 to retrieve the embeddings for all assets in the current scene, focusing specifically on the ones that are chairs. The embeddings contain encoded information about various attributes of the assets, such as their color (e.g., red), type (e.g., chair), and other visual/textual details.

Once the search component 218 retrieves the embeddings for one or more (e.g., one, some, or all) chairs in the scene, the search component 218 applies the query conditions (i.e., “red” to filter out the chairs that do not match the color condition. The color information is encoded within the embeddings, allowing the search component 218 to compute similarity scores or directly filter for assets that have the “red” color attribute. After filtering the embeddings, the search component 218 identifies the red chairs that exist in the living room scene. The system returns the relevant results (e.g., asset IDs, positions, and/or visual representations) to the user device, showing all red chairs in the scene.

In an example illustration of how the asset graph service 212 works when an in-scene search query 216 is issued, the query 216 may be “all red chairs in this living room scene.” The search component 218 responsively queries the asset graph service 212 to identify all objects in the scene categorized as chairs. The asset graph service 212 analyzes the scene's graph structure to find all chair nodes and retrieves their spatial relationships (e.g., where each chair is positioned in the living room). Simultaneously, the search component 218 retrieves the embeddings for each chair from the search backend 220, which contain visual information like the color of each chair. The search component 218 combines the graph data (spatial relationships) with the embedding information (color attributes) to filter out any chairs that are not red. The graph data helps the search component 218 to understand the positions of the chairs, while the embeddings help refine the query based on visual attributes. The result is a list of red chairs in the living room scene, including their positions within the scene. The user or AI agent 112 receives the filtered results based on both the scene's graph structure and the embeddings.

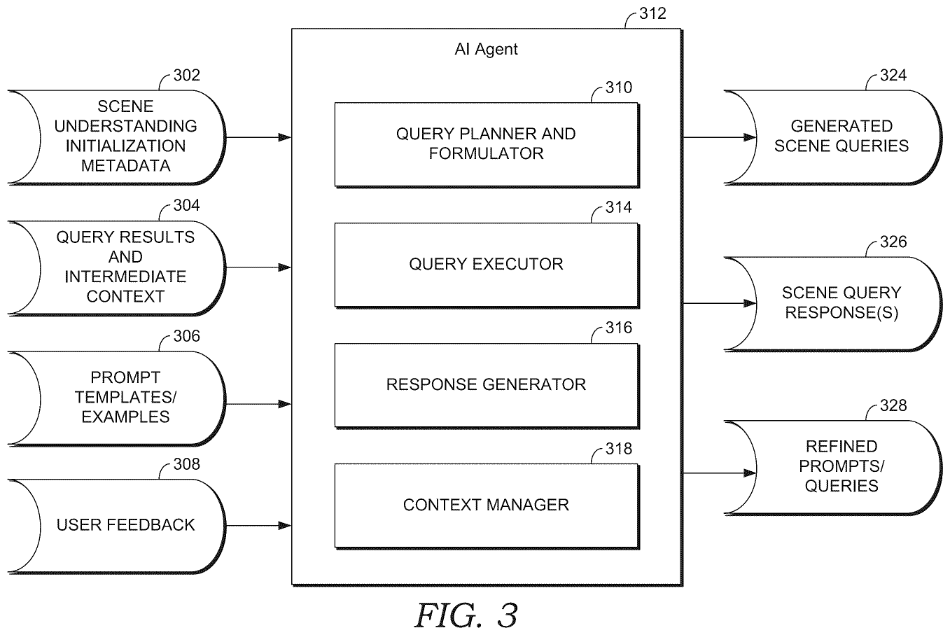

FIG. 3 is a block diagram illustrating the components of an AI agent 312 (e.g., the AI agent 112), as well as its inputs (i.e., scene understanding initialization metadata 302, query results and intermediate context 304, prompt templates/examples 306, and user feedback 308) and outputs (i.e., generated scene queries 324, scene query responses 326, and refined prompts/queries 328), according to some embodiments. The AI Agent 312 includes a Query Planner and Formulator 310, a Query Executor 314, a Response Generator 316, and a Context Manager 318.

The Query Planner and Formulator 310 is responsible for planning the sequence of scene queries and formulating them contextually using Scene Understanding Initialization Metadata 302 (e.g., as generated by the scene initialization component 106), Prompt Templates/Examples 306, and User Feedback 308. The Query Planner and Formulator 310 analyzes the initialization metadata 302 to understand the objects present and their contextual roles, using this to generate the first set of queries in 324. The Query Planner and Formulator 310 then leverages Prompt Templates and examples (e.g., example Input-Output Pairs) 306 to construct context-aware queries, ensuring that the questions are relevant to the scene context. The Query Planner and Formulator 310 also uses User Feedback 308 to adapt queries dynamically, refining them based on user interactions. The output from this component is Generated Scene Queries 324, which are then sent to the Query Executor 314 for execution.

In some embodiments, the query planner and formulator 310 uses predefined rules to determine the order of queries, such as resolving spatial proximities before exploring contextual dependencies or hierarchical relationships (e.g., if a lamp is near a sofa, then check if the lamp illuminates the sofa. In some embodiments, the query planner and formulator 310 uses prompt engineering and example input-output pairs in 306 to dynamically generate natural language queries based on scene context and user feedback. In some embodiments, the formulator 310 leverages a dependency graph maintained by the Context Manager 318 to identify gaps in scene understanding and trigger follow-up queries. In some embodiments, the formulator 310 applies reinforcement learning to optimize the sequence and relevance of queries based on the effectiveness of previous queries and user feedback. For example, formulator 310 learns that queries related to illumination are more relevant for scenes containing light sources, adjusting the query order accordingly.

The Query Executor 314 is responsible for executing the formulated scene queries by interacting with the multi-data store indexing system 108 through the API Layer 110. The Query Executor 314 receives Generated Scene Queries 324 from the Query Planner and Formulator 310 and translates them into database-specific queries compatible with the spatial database, graph database, and/or dependency index. The Query Executor 314 retrieves the relevant scene data by issuing spatial, semantic, and/or dependency queries as needed. The Query Executor 314 then formats the retrieved information as Scene Query Responses 326, which are sent to the Response Generator 326 for contextual processing.

The Query Executor 314 uses query translation and optimization algorithms to efficiently execute scene queries against the multi-data Store indexing system 108. For example, Query Executor 314 first applies Natural Language Processing (NLP) parsing to translate natural language queries generated by the Query Planner and Formulator 310 into database-specific queries compatible with the spatial database, graph database, and dependency index. In some embodiments, Query Executor 314 uses query optimization techniques such as query rewriting, indexing strategies, and/or caching to minimize query execution time. For spatial queries, Query Executor 314 uses spatial indexing algorithms like oct-tree traversal for proximity and containment queries, ensuring efficient geometric reasoning. For semantic queries, Query Executor 314 leverages graph traversal algorithms (e.g., Depth-First Search or Breadth-First Search) to navigate contextual dependencies in the graph database. For dependency queries, Query Executor 314 uses directed graph traversal to resolve hierarchical relationships and cross-scene dependencies stored in the dependency index. These algorithms enable the Query Executor 314 to dynamically reason about scene relationships and efficiently retrieve relevant scene data.

The Response Generator 316 processes the Scene Query Responses 326 received from the Query Executor 314 and converts them into context-aware insights and natural language descriptions. The Response Generator 316 uses Prompt Templates/Examples 306 to generate descriptive explanations of the scene relationships and dependencies, making the query results understandable and contextually relevant. The Response Generator 316 then produces Refined Prompts/Queries 328 by analyzing the current state of scene understanding and identifying what additional information is needed. These Refined Prompts/Queries 328 are sent to the Query Planner and Formulator 310 for continued scene exploration, ensuring that the querying loop continues until all relevant spatial, semantic, and dependency-based information is fully understood and indexed.

In some embodiments, the Response Generator 316 uses text generation algorithms powered by large language models (LLMs), such as GPT-based models, to convert query results into natural language insights. Response Generator 316 uses contextual embedding alignment to maintain semantic coherence when generating descriptions, ensuring that the natural language is contextually relevant to the scene. Response Generator 316 also applies template-based natural language generation using Prompt Templates and Example Input-Output Pairs 306, which help in structuring responses for common queries (e.g., spatial relationships or functional roles). Additionally or alternatively, Response Generator 316 uses entity resolution algorithms to consistently reference scene objects across multiple queries, ensuring continuity and coherence in narrative explanations. These algorithms enable the Response Generator 316 to provide accurate, context-aware, and human-readable explanations of the scene.

The Context Manager 318 is responsible for tracking query states and intermediate context, ensuring that the AI agent maintains an accurate state of scene understanding. The Context Manager 318 receives Scene Understanding Initialization Metadata 302 and Query Results and Intermediate Context 304 from previous queries. In some embodiments, the Context Manager 318 maintains a dependency graph of expected relationships, using this to identify gaps in scene understanding. In these embodiments, Context Manager 318 compares expected relationships (e.g., from prompt templates) with retrieved results and triggers follow-up queries when discrepancies or gaps are detected. The Context Manager 318 also processes User Feedback 308 to update the query state and adaptively refine queries. The output is Refined Prompts/Queries 328, which are sent to the Query Planner and Formulator 310 for iterative refinement, ensuring that the querying loop is dynamic and context-aware.

In some embodiments, the Context Manager 318 uses state tracking and dependency graph algorithms (e.g., Directed Acyclic Graph (DAG) traversal) to maintain the current state of scene understanding and identify gaps that require follow-up queries. In some embodiments, Context Manager 318 utilizes a dynamic dependency graph that tracks expected spatial, semantic, and/or dependency-based relationships. For example, the dynamic dependency graph tracks expected relationships by using prompt templates and example input-output pairs that define the anticipated spatial, semantic, and dependency-based connections between scene entities. In some embodiments, Context Manager 318 compares the expected relationships with retrieved query results using graph diff algorithms (e.g., subgraph isomorphism for pattern matching, graph edit distance for measuring structural differences, delta encoding for change tracking, and structural similarity index for contextual alignment to detect missing or incomplete connections), triggering follow-up queries to resolve the gaps.

In some embodiments, the Context Manager 318 additionally or alternatively employs state management algorithms (e.g., Finite State Machines (FSM) for query state transitions, Markov Decision Processes (MDP) for probabilistic state management) to track query states (e.g., pending, resolved, incomplete) and intermediate context, ensuring that the querying loop is iteratively refined. To prioritize follow-up queries, in some embodiments the Context Manager 318 applies rule-based reasoning and conditional logic, ensuring that the AI agent dynamically explores the scene in a context-aware manner. This enables the Context Manager 318 to maintain query continuity, resolve ambiguities, and adaptively refine queries until a threshold of completeness is reached. In some embodiments, the Context Manager 318 reads session logs to track the history of queries, responses, and intermediate states, ensuring that the AI agent maintains contextual continuity across multiple queries.

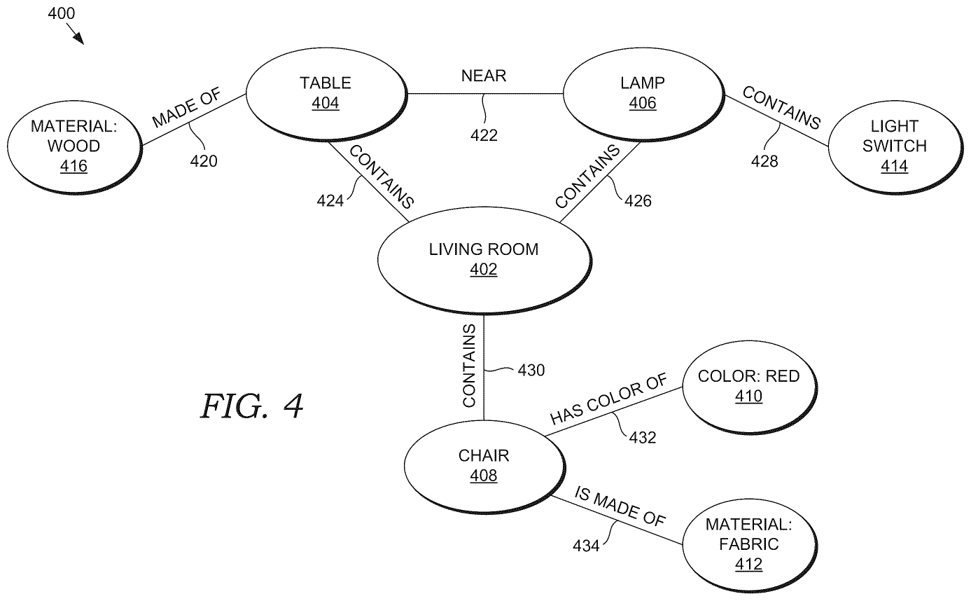

FIG. 4 is a schematic diagram illustrating an example graph data structure 400 (e.g., stored to the graph database 108-1 of FIG. 1) that contains graph data, according to some embodiments. In some embodiments, the graph data structure 400 represents a Directed Acyclic Graph (DAG), specifically a hierarchical DAG with directional edges that represent relationships like “contains”, and “made of”. In some embodiments, the graph data structure 400 represents what is built by the asset graph builder 208 of FIG. 2.

The graph data structure 400 contains multiple nodes 402, 404, 406, 408, 410, 412, 414, and 416, and multiple edges 420, 422, 424, 426, 428, 430, 432, and 434 that connect the nodes. The graph data structure 400 specifically represents a 3D scene of a living room containing a red chair, a wooden table, and a lamp. In this graph data structure, nodes represent different assets and properties (objects, materials, colors), while edges represent the relationships between these assets (spatial, hierarchical, material). The graph structure 400 enables efficient querying of the scene by navigating through these relationships, allowing searches based on attributes like spatial proximity, object type, material, or other connections between the assets. In other words, this graph data structure 400 represents relationships between different digital assets (e.g., 3D models, objects in a scene) based on various characteristics like spatial positioning, hierarchy, and dependencies between objects in a 3D scene or environment.

The Living Room node 402 represents the scene itself, containing the other objects—i.e., the Chair Node 408, the Table node 404, and the Lamp node 406. The Chair node 408 represents a chair, which is a child of the living room node 402. The Color: Red node 410 represents the visual property (color) of the chair. The Material: Fabric node 434 represents the material used in the chair. The Table node 404 represents a wooden table. The Material: Wood node 416 represents the material used for the table. The Lamp node 406 represents a lamp, which has an interaction with or contains a light switch. The Light Switch node 414 represents the object that controls the lamp.

With respect to the edges, there are hierarchical edges, spatial edges, dependency edges, and material edges. The hierarchical edges include edges 424, 426, and 430, which connect the Living Room node 402 to the Chair node 408, Table node 404, and Lamp node 406, indicating that these objects are part of the scene. The spatial edge 422 is an edge between the Lamp node 406 and the 4 able node 404, which represents their spatial relationship (e.g., “Lamp near Table”). The dependency edge 428 is an edge between the Lamp node 406 and the Light Switch node 414, which represents a dependency (the light switch controls the lamp). The material edge 420 is an edge from the Wood node 416 to the Table node 404, representing that the table is made from wood and/or has a wood-like material property or appearance.

A query like “red chairs in the living room” would traverse the graph data structure 400, starting from the Living Room node 402, looking for Chair nodes that have an edge to a Color node with the value Red, such as node 410. A query like “objects near the table” would traverse the graph data structure 400, starting at the Table node 404, and follow the spatial edges to find any connected objects within the scene (e.g., Lamp node 406).

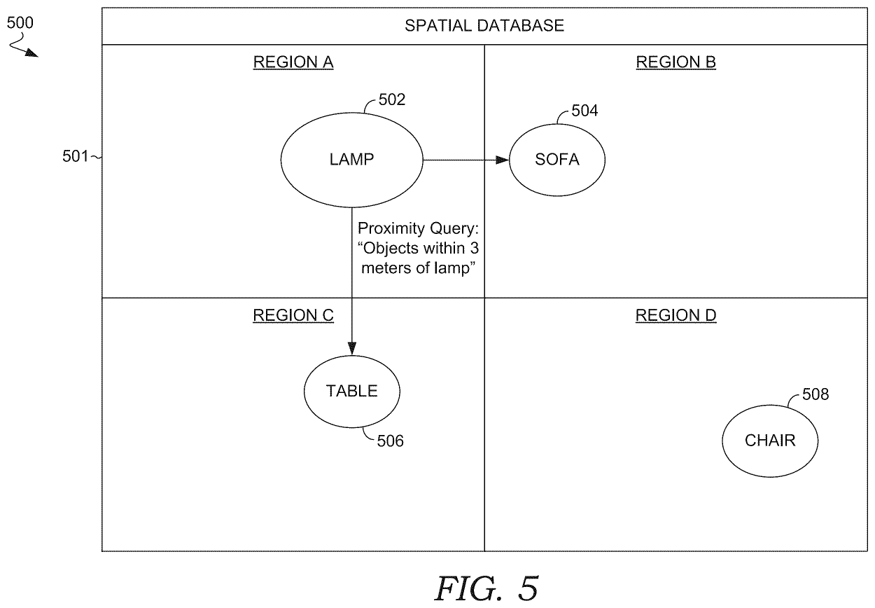

FIG. 5 is a schematic diagram illustrating a quad-tree stored to a spatial database (e.g., spatial database 108-2 of FIG. 1), according to some embodiments. The outer box 501 represents the total spatial area (e.g., the room or scene being indexed). The area is divided into quadrants or regions (based on an oct-tree or quad-tree structure)-Region A (top left) contains objects like a lamp 502, Region B (top right) contains objects like a sofa 504, Region C (bottom left) contains objects like a table 506, and Region D (bottom right) contains objects like a chair 508. As illustrated in FIG. 5, an AI agent or human user issues a query, such as “What objects are within 3 meters of the lamp?” Responsively, some embodiments highlight objects in the lamp's 502 region and/or adjacent regions. As illustrated by the arrows in FIG. 5, the sofa 504 and table 506 are within 3 meters of the lamp 502, but the chair 508 is not within 3 meters of the lamp 502.

In some embodiments, the spatial database (e.g., 108-2) utilizes a quad-tree structure to efficiently index and organize spatial data within the scene, enabling fast and accurate spatial queries. The quad-tree structure recursively divides the total spatial area into quadrants (e.g., Regions A, B, C, and D), storing objects within the corresponding regions based on their 3D coordinates. This hierarchical representation allows the indexing system 108 to quickly narrow down the search space by focusing on the region containing the queried object and its adjacent regions, rather than scanning the entire scene.

For example, when the AI agent issues the query “What objects are within 3 meters of the Lamp?” the indexing system 108 first checks Region A (where the lamp 502 is located) and adjacent regions (e.g., Region B and Region C) by calculating Euclidean distances between the lamp 502 and other objects within these regions. The quad-tree structure enables this by traversing the tree nodes corresponding to Region A, B, and C, efficiently retrieving the sofa 504 and table 506 as nearby objects while pruning the search for Region D (where the chair 508 is located) because Region D is outside the 3-meter range. This spatial indexing and hierarchical search ensure optimal query performance and context-aware scene understanding.

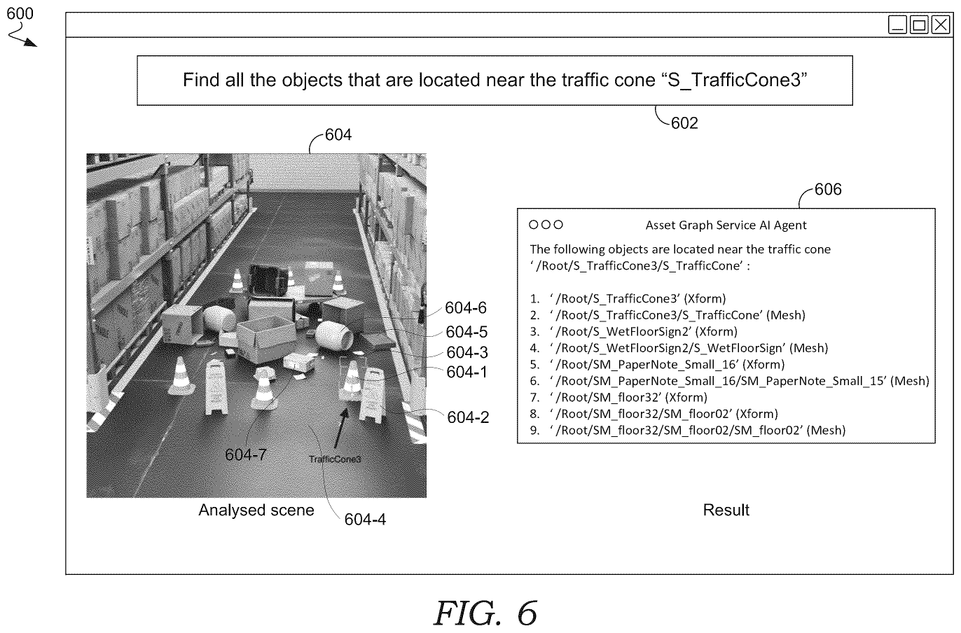

FIG. 6 is a screenshot of an example user interface page 600 illustrating execution of a proximity search, according to some embodiments. At a first time a user uploads a digital asset 604, which is an image of a scene that includes various elements or objects. In response to receiving an indication that the user has uploaded the digital asset 604, the scene data extractor 106 processes digital asset 604 by detecting objects, extracting spatial properties, and the multi-data store indexing system 108 indexes this scene data. When the user (or AI agent) issues the query “Find all the objects that are located near the traffic cone ‘S_TrafficCone3’” the query planner and formulator 310 in the AI agent 312 generates an initial spatial query to the spatial database, retrieving objects within a certain proximity range. The query executor 314 executes this query 602, and the response generator 316 processes the results, returning or computing an initial set of nearby objects. In some embodiments, the AI agent continues the query loop, using the context manager 318 to track expected spatial relationships and detect gaps in scene understanding. For instance, if the initial response lacks functional dependencies (e.g., whether these objects interact with or obstruct the traffic cone), the AI agent may generate follow-up semantic or dependency queries to the graph database or dependency index, refining the results further. The iterative querying loop continues until the AI agent reaches a completeness threshold or receives user feedback, ensuring that the final response is not just based on direct proximity but also enriched with meaningful contextual relationships, providing the user with a comprehensive, context-aware understanding of the scene.

In some embodiments, the search component 218 sends a request to the AGS 212 to find all objects that have an edge to S_TrafficCone3 labeled “near” or similar spatial relationships. The AGS 212 searches through the graph to identify all objects that are spatially connected to the S_TrafficCone3 node via a proximity edge (representing objects that are “near”). The AGS 212 returns a list of nearby objects (nodes connected via spatial edges) to the search component 218. These include objects, such as the floor sign 604-2, paper note 604-3, paper note 604-4, box 604-5, barrel 604-6, and box 604-7 positioned close to S_TrafficCone3. After (or before) identifying the relevant objects that are spatially near S_TrafficCone3 604-1 from the AGS 212, the search component 218 further processes the query 602 by retrieving the embeddings of these objects from the search backend 220. The search component 218 sends a request to the search backend 220 to retrieve the embeddings for each of the objects identified from the graph query (e.g., cones, paper notes, boxes, barrels). The search backend 220 looks up the embeddings for these objects, which were generated during the indexing phase by the indexing system 108. These embeddings might encode information such as the color, shape, and material of the objects. The search component 218 retrieves the embeddings and processes them to filter or rank the objects if the user query includes additional conditions (such as filtering objects by material or other attributes). After the search component 218 completes both the graph query and the embedding retrieval, search component 218 combines the spatial data from the AGS 212 (showing which objects are near S_TrafficCone3 604-1) with the embeddings from the search backend 220 to refine the results further if needed.

The AI agent returns the “Result” 606, which is a list of objects near S_TrafficCone3 604-1 (i.e., the floor sign 604-2, paper note 604-3, paper note 604-4, box 604-5, barrel 604-6, and box 604-7) to the user device. The returned data includes the spatial relationships (proximity to S_TrafficCone3) and other asset properties derived from the embeddings (e.g., color, material, etc.). In some embodiments the “Results” 606 alternatively or additionally is an output image that represents the digital asset 604, except that each of the objects 604-1, 604-2, 604-3, 604-4, 604-5, 604-6, and 604-7 are highlighted, which indicates that these are the objects that are located near the traffic cone 604-1 according to the query 602. For example, some embodiments superimpose pixel data (e.g., a certain color) or other data (e.g., a bounding box) over these objects to indicate that they are all objects near the target traffic cone 604-1.

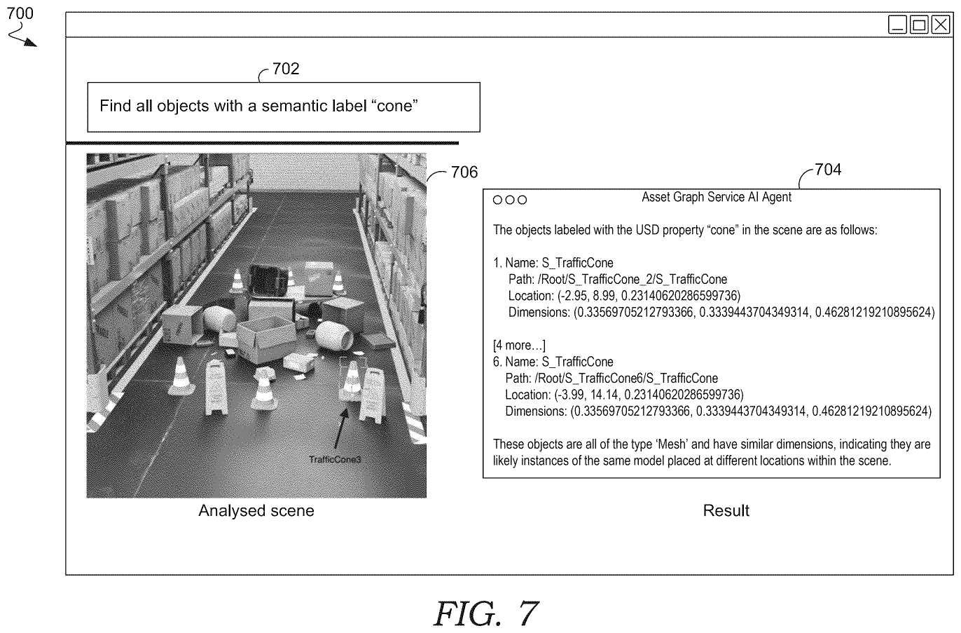

FIG. 7 is a screenshot of an example interface page 700 illustrating a search for a particular object, according to some embodiments. The user interface 700 presents a visual representation of a 3D scene 706, allowing a user (or the AI agent) to issue natural language or structured queries 702—“Find all objects with a semantic label ‘cone’”—through an interactive input field. Upon receiving the query 702, the AI agent's Query Planner and Formulator 310 interprets the input and generates a semantic query (a different query than 702) targeting objects with the label “cone” in the graph database 108-1, which stores semantic labels linked to scene entities (e.g., as USD properties). The Query Executor 314 accesses the indexed scene data via the API layer 110 and retrieves relevant objects, including their names, file paths, spatial coordinates, and/or dimensions, as stored in the spatial database 108-2 and graph database 108-1. The Response Generator 316 formats the results into a clear, human-readable response, highlighting the matched objects and noting patterns such as shared geometry or instancing. This response is displayed within the UI as 704, optionally overlaid on the 3D scene 706 for spatial context, enabling users to interactively explore and verify semantic relationships across the environment.

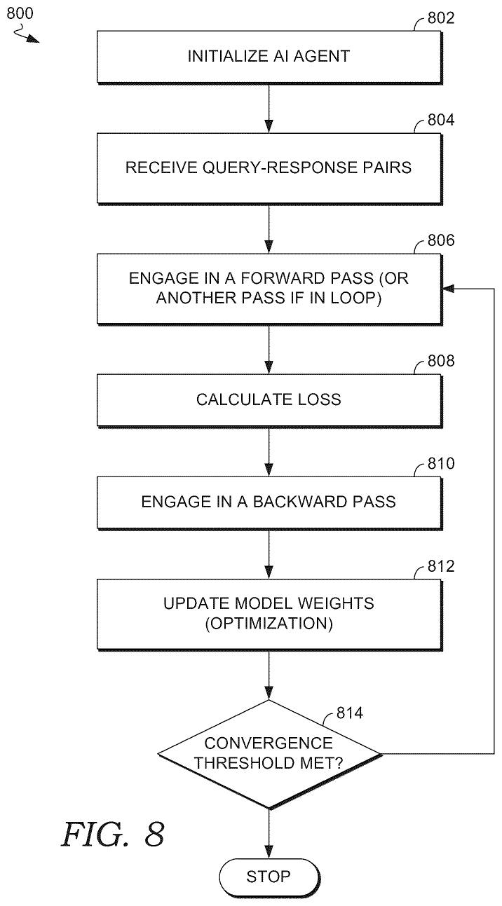

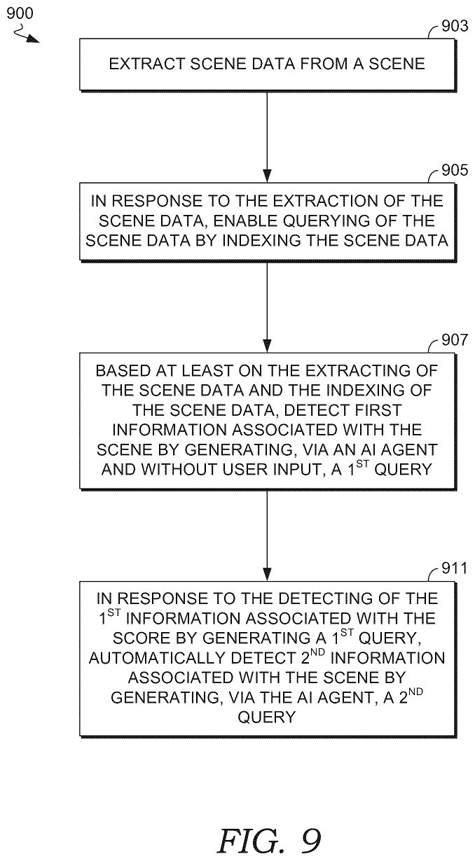

FIGS. 8 through 9 are flow diagrams of example methods. Each block of methods 800 and/or 900 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the process 400 is described, by way of example, with respect to the pipeline 100 of FIG. 1, pipeline 200 of FIG. 2, and/or pipeline of FIG. 3. However, these processes may additionally or alternatively be executed by any one system, or any combination of systems, including, but not limited to, those described herein.

FIG. 8 is a flow diagram illustrating how an AI agent is trained or fine-tuned, according to some embodiments. Per block 802, the AI agent is initialized. In some embodiments, the AI agent is initialized as a pretrained language model capable of understanding and generating queries related to spatial, semantic, and/or dependency-based reasoning. This initialization may involve loading a transformer-based model (e.g., a fine-tuned LLM) with pre-existing knowledge of scene relationships and query structures. The model is then prepared to process input-output pairs for training. For example, a pretrained multimodal AI model (e.g., a fine-tuned LLaMA or GPT variant) is loaded with scene-related knowledge, such as interpreting proximity-based spatial relationships and object attributes.

Per block 804, some embodiments receive query-response pairs. Such queries in the pairs include spatial queries, semantic queries, dependency queries, rule validation queries, and/or user feedback refinement queries. Spatial queries retrieve information about the geometric properties and relationships of objects in a scene, such as proximity, distance, containment, or collision (e.g., “What objects are within 3 meters of the traffic cone?”). Semantic queries extract functional or contextual relationships between objects, such as illumination, usage, or classification (e.g., “Does the lamp illuminate the table?”). Dependency queries identify hierarchical relationships or cross-scene dependencies between objects or assets (e.g., “Is this door referenced in multiple scene configurations?”). Rule validation queries check if objects in the scene comply with predefined constraints, such as safety regulations or design standards (e.g., “Are all fire extinguishers mounted below 1 meter from the ground?”). User feedback refinement queries adjust or refine previous queries based on human interaction, preferences, or additional constraints (e.g., “Recheck within a 2-meter radius using finer detail.”).

Each query has an associated expected response, including direct answers, query loop refinements, and/or follow-up questions. A “direct answer” is response that directly satisfies the query without requiring additional refinement (e.g., “The table is 2 meters away from the lamp.”). A “query loop refinement” is an adjustment made to a query or its execution based on intermediate results to improve accuracy or completeness (e.g., “Rechecking at a finer resolution to detect occlusions.”). A “follow-up question” is an additional query or command generated by the AI agent to resolve missing context or ambiguities in the initial response (e.g., “Is the table obstructing the lamp's light?”). An example of a query-response pair include: Query: “What objects are within 3 meters of the traffic cone ‘S_TrafficCone 3’?” Expected Response: “Barrier_B12, RoadSign_07, and ConstructionDrum_C4 are within 3 meters.”
During training, in some embodiments training scene data (e.g., an example scene with objects) is paired with query-response pairs, where the model learns to retrieve relevant spatial, semantic, and/or dependency-based relationships given a specific scene structure. For example, if a scene contains a table, a lamp, and a chair, the AI agent is trained to generate spatial queries (e.g., “What objects are near the lamp?”), validate expected illumination relationships, and recognize cross-scene dependencies. Through this process, the AI agent learns patterns in scene structures, refining how the AI agent issues, refines, and completes queries based on the scene context.

Per block 806, some embodiments engage in a forward pass (or another pass if in loop). For instance, a query (e.g., “What objects are within 3 meters of the traffic cone ‘S_TrafficCone3’?”) is first tokenized and converted into a dense vector representation (embedding) using a pretrained transformer model (e.g., a fine-tuned LLM). Simultaneously, scene-related objects, relationships, and prior query-response pairs are also embedded into a vector space, ensuring that the AI agent can contextually interpret the query within the scene. For example, the tokenized query is mapped into an embedding space where “traffic cone” is closer in meaning to “barrier” than “streetlight,” aiding in retrieval of relevant scene objects.

The AI agent retrieves relevant embeddings from the spatial database, graph database, and dependency index to understand the scene context. These embeddings represent spatial relationships (e.g., proximity scores), semantic attributes (e.g., “traffic cone is a road marker”), and dependencies (e.g., “traffic cone is referenced in another scene”). The model concatenates the query embedding with scene embeddings and passes them through a neural architecture (e.g., transformer layers) to generate context-aware scene understanding. For example, if the retrieved embeddings show that objects “barrier” and “construction drum” have high proximity similarity to “traffic cone,” they are prioritized in query resolution. The neural model generates an output based on the concatenated input embeddings and prior learned query-response pairs using an autoregressive decoder (e.g., GPT-like architecture) or a structured retrieval model for database-specific queries. The output is a probability distribution over possible responses, selecting the most likely structured query response. For example, the AI agent might generate “Barrier_B12, RoadSign_07, and ConstructionDrum_C4 are within 3 meters of ‘S_TrafficCone 3’.” In some embodiments, the context manager compares the generated response embeddings with expected relationships stored in prior query-response pairs and the dependency graph. If an expected relationship is missing or an ambiguity is detected, the AI agent generates a follow-up question or refines the query before proceeding.

Per block 808, some embodiments calculate a loss. The model compares its generated response with the expected response (ground truth) and computes a loss function (e.g., Cross-Entropy Loss for text generation or Mean Squared Error for numerical proximity calculations). The loss measures how much the model's output deviates from the correct response. For example, if the AI agent mistakenly excludes a relevant nearby object in its output, the loss function reflects the missing relationship, prompting a correction in the next step.

In some embodiments, there are multiple losses computed, such as direct response loss (ensuring the AI agent generates correct answers), follow-up query loss (determining whether additional queries are needed for scene refinement), and intermediate data extraction loss (ensuring scene representations and embeddings accurately capture spatial, semantic, and dependency-based relationships). For example, when responding to the query “What objects are within 3 meters of the traffic cone ‘S_TrafficCone3’?”, the AI agent computes direct response loss based on how accurately the AI agent retrieves the correct objects, follow-up query loss if additional spatial refinements are necessary, and intermediate data extraction loss if the retrieved scene relationships deviate from expected embeddings. In some embodiments, after each individual loss is computed, the losses are aggregated into a total loss function to optimize the AI agent's reasoning capabilities. For example, the system may compute a weighted sum of all losses, where the total loss is the combined measure of how much the AI agent's generated responses, follow-up queries, and scene representations deviate from the expected correct outputs, with each type of loss weighted based on its importance to ensure balanced learning and optimization.

Per block 810, some embodiments engage in a backward pass. During the backward pass, the model calculates gradients using backpropagation, determining how each model parameter contributed to the error. This step allows the AI agent to adjust its internal query formulation and reasoning mechanisms. For example, if the AI agent incorrectly prioritizes a distant object over a nearby one, the backward pass adjusts the model's query weighting mechanisms, making the AI agent better at selecting relevant spatial relationships.

Per block 812, some embodiments update model weights (Optimization). The AI agent updates its neural network weights using an optimization algorithm such as Adam or Stochastic Gradient Descent (SGD). These updates refine how the model predicts scene relationships, query refinements, and response generation. For example, after optimization, the AI agent improves at generating follow-up queries, ensuring the AI agent correctly identifies obstructions in spatial queries or missing dependencies in hierarchical scene relationships. In other words, after computing individual losses for direct responses, follow-up queries, and scene representations, the system aggregates them into a total loss function. The model then calculates the gradients of the total loss with respect to each weight in the neural network using automatic differentiation (e.g., PyTorch's Autograd or TensorFlow's gradient tape). These gradients indicate the direction and magnitude of adjustments needed for each parameter. The optimizer (block 812) then updates the model's weights by applying the gradients in small steps, scaled by a learning rate, ensuring that the model gradually improves its predictions over multiple training iterations.

Per block 814, whether a convergence threshold is met (If yes, stop, If no, go back to block 806) is determined. The model checks whether the convergence threshold has been met, meaning that loss is below a predefined threshold or accuracy on validation queries has plateaued. If the model has converged, training stops; otherwise, the model loops back to block 806 for further refinement. For example, if the model is still misidentifying cross-scene dependencies, additional iterations improve its accuracy. Once the model consistently returns the correct scene relationships, training is complete.

In some embodiments, the model is trained to detect gaps by incorporating a gap detection classifier alongside its query generation process. During training, each query-response pair is labeled with whether the response is complete or requires a follow-up query, enabling the model to learn when a query loop should continue. The model processes the input query, scene embeddings, and retrieved results, then compares expected relationships (from prompt-tuned templates or a dependency graph) with the retrieved outputs. If missing relationships are detected, the model predicts a gap classification score, which is optimized, for example, using Binary Cross-Entropy Loss (for gap detection classification) and Cross-Entropy Loss (for generating appropriate follow-up queries). Additionally, in some embodiments graph diff algorithms are used to compare retrieved scene relationships against expected structures, reinforcing the model's ability to refine queries when inconsistencies arise. By training on annotated datasets of scene queries with known missing information, the AI agent learns to iteratively refine its responses, ensuring comprehensive scene understanding.

The AI agent can be alternatively prompt engineered by designing structured prompt templates that guide its query generation, gap detection, and/or iterative reasoning without modifying the model's internal weights. Instead of fine-tuning, example-driven prompts are crafted with few-shot learning techniques, where the AI agent is provided with examples of queries, expected responses, and when to generate follow-up questions. These prompts incorporate contextual cues, conditional logic, and/or role instructions to help the agent infer when additional queries are needed. For example, a prompt might include: “If a spatial query returns objects but lacks an occlusion check, ask ‘Is any object blocking visibility?’ before returning the result.” Additionally, chain-of-thought prompting can be used to break down complex scene relationships into step-by-step reasoning steps, allowing the agent to explore the scene in a structured manner. This prompt engineering approach ensures the AI agent adapts dynamically to different scene queries without requiring extensive fine-tuning.

FIG. 9 is a flow diagram of an example process for engaging in scene understanding via query looping by an AI agent, according to some embodiments. Per block 903, some embodiments extract scene data from a scene. Alternatively or additionally, some embodiments obtain extracted scene data of a scene (e.g., from the indexing system 108 receives scene data from the scene data extractor 106). In some embodiments, the extracting of the scene data includes detecting, via object detection, an object in the scene. For example, using a pretrained YOLO or Faster R-CNN model, some embodiments analyze the scene and identify objects, such as detecting a fire extinguisher in an office environment by classifying its bounding box and assigningthe identified object a semantic label for indexing in the graph and spatial databases.

Some embodiments additionally or alternatively extract a spatial property of the scene. A “spatial property” defines the geometric characteristics and/or positional relationships of an object within a scene, including coordinates, orientation, scale, distance, proximity, containment, and/or collision status. In some embodiments, extracting a spatial property involves leveraging object detection and 3D scene parsing techniques, where objects are first detected using bounding boxes or segmentation masks, and their positions are mapped onto a universal coordinate system (e.g., in meters relative to the scene origin). Techniques such as LiDAR point cloud processing, depth estimation from stereo images, or parsing 3D file formats (e.g., USD, glTF) can extract absolute spatial data. Additionally, spatial indexing structures like quad-trees or oct-trees efficiently store and query spatial properties, enabling the AI agent to compute relationships such as object adjacency, relative orientation, and potential occlusions dynamically.

A “visual property” of a scene refers to the perceptual attributes of objects that define their appearance and/or material characteristics, including color, texture, reflectivity, transparency, shading, and/or material composition. Examples include RGB color values (e.g., a red traffic cone), material types (e.g., wood, metal, plastic), and surface properties like glossiness or roughness. Some embodiments extract visual properties using Vision-Language Models (VLMs) or computer vision techniques such as semantic segmentation and feature extraction. For instance, a VLM like CLIP can process an image of an object and output a textual description (e.g., “A glossy red fire extinguisher”), while deep learning-based material recognition models can classify object materials based on texture patterns and spectral reflectance analysis. These extracted properties are then stored in the graph database for semantic queries and used in AI-driven scene reasoning.

A “natural language semantic label” is a text-based descriptor that categorizes an object within a scene based on its identity, function, or contextual role, making the label interpretable for AI-driven reasoning. Examples of semantic labels include object type labels (e.g., “fire extinguisher,” “table,” “lamp”) and functional role labels (e.g., “emergency equipment,” “seating furniture,” “light source”). Some embodiments extract semantic labels using Vision-Language Models (VLMs) such as CLIP or BLIP, which process an image of the object and generate a context-aware textual description. Additionally, pretrained object detection models (e.g., YOLO, Faster R-CNN) can classify detected objects and assign taxonomy-based labels from datasets like COCO or OpenImages. Extracted labels are then stored in the graph database, enabling AI agents to query, infer relationships, and refine scene understanding using natural language queries.

In some embodiments, an embedding that captures a property of the scene is a high-dimensional vector representation that encodes specific spatial, visual, and/or semantic attributes of objects or relationships within a scene. These embeddings allow the AI agent to perform similarity comparisons (e.g., via Euclidian or Cosine distance), clustering, and reasoning about scene elements in a structured way. For example, a CLIP embedding can encode both image and text features, enabling the system to compare a scene's visual features with descriptive labels (e.g., ensuring a detected red fire extinguisher aligns with the semantic concept “fire safety equipment”). Similarly, spatial embeddings derived from scene graphs can encode relative object positions so that the AI agent can infer spatial relationships (e.g., “The table is near the chair” based on cosine similarity between their position vectors). These embeddings are generated using pretrained neural networks and stored by the indexing system, facilitating fast scene queries, retrievals, and AI-driven analysis.

Continuing with block 903, some embodiments additionally or alternatively extract an object-assigned data attribute. An “object-assigned data attribute” refers to abstract and/or system-level metadata assigned to one or more objects in a scene. In some embodiments, the object-assigned data attributes includes a physical property, a technical specification, an origin identifier, a value indicator, a reference to an external system, and/or a dynamic data associated with the object from a real-time data source. and is not necessarily derived from visual or spatial analysis. These attributes may originate from external databases, system-level object models, or runtime data sources, and can include static descriptors (e.g., technical specifications) or dynamic information (e.g., sensor data from IoT systems in digital twins).

A “physical property” is a tangible characteristic of an object that reflects its physical composition, condition, or interaction behavior. This may include data such as material type (e.g., metal, plastic), weight, dimensions, reflectivity, thermal resistance, or rigidity. These properties can be extracted from 3D asset metadata or CAD models. For example, a metal fire extinguisher may have a physical property set indicating its material as steel, its weight as 5.2 kg, and resistance to high temperatures. A “technical specification” is a structured, descriptive data set detailing an object's engineering, design, or operational parameters, which may be provided by manufacturers or asset creators. This may include model numbers, voltage ratings, safety certifications, mechanical tolerances, and/or performance limits. For example, a surveillance camera object in the scene may have technical specifications such as “Model XT-410; 12V DC; 1080p resolution; IP67 waterproof rating.”

An “origin identifier” indicates the source or provenance of the object, such as where it was sourced from (e.g., the particular scene or object references another source scene or object), who manufactured the object, or which content library or asset management system it belongs to. This allows tracking the lineage and authenticity of scene elements. For example, sofa asset may include an origin identifier such as “Asset ID #45623 from ‘OfficeFurniture_Assets_v3’ library, Vendor: Acme Corp.” A “value indicator” captures economic, operational, or priority-based value assigned to the object. This may include monetary cost, maintenance priority, asset lifecycle status, or replacement urgency. For example, a server rack in a digital twin of a data center may have a value indicator such as “Asset Value: $15,000; Maintenance Priority: High; End-of-life: 2026.”

A “reference to an external system” links the object to an external database, enterprise system, or service, such as a part number in an inventory management system, a BIM (Building Information Model) reference, or a digital asset registry ID. These links enable integration with operational and administrative systems. For example, a fire door in the scene may contain a reference like “Linked Inventory ID: INV-00031124 in SAP Asset Management”, enabling dynamic lookup and control.

“Dynamic data from a real-time source” refers to live, continuously updated information associated with an object, typically in a digital twin or sensor-integrated environment. This includes data from IoT devices, telemetry feeds, occupancy sensors, or environmental sensors embedded in or related to the object. For example, A virtual autonomous vehicle in a simulated urban environment may include dynamic data such as “Front radar detected object at 12.6m; Lidar point cloud updated at t=0.25 s; Left camera feed active; Current velocity: 28 km/h”, where these values are continuously updated by a real-time sensor simulation engine. This dynamic information may be fetched via a virtual sensor API layer, enabling the AI agent to reason about the vehicle's interactions with its surroundings, such as proximity to pedestrians or other vehicles.

Per block 905, in response to the extracting of the scene data, some embodiments enable querying of the scene data by indexing the scene data or storing the scene data using an index. For example, some embodiments store the extracted data into a spatial database, graph database, and/or a dependency index. The spatial database stores geometric properties using structures such as quad-tree or oct-tree structures for efficient spatial queries (e.g., “What objects are within 3 meters of the lamp?”). The Graph Database organizes semantic relationships as a node-edge structure, enabling contextual queries (e.g., “Does the lamp illuminate the table?”). The Dependency index tracks hierarchical scene dependencies (e.g., “Is this door shared between multiple scenes?”). The system automatically formats and indexes the scene data upon extraction, allowing the AI agent to retrieve and refine scene understanding dynamically through structured queries without reprocessing the raw scene data.

Per block 907, based at least on the extracting of the scene data and the indexing of the scene data (blocks 903 and 907), detect first information associated with the scene by generating, via an AI agent and without user input, a first query. For example, the AI agent autonomously detects first information by generating an initial query based on scene context, indexed relationships, and predefined query strategies. The query planner and formulator 310 constructs the first query using prompt engineering or a tuned model trained on example query-response pairs, ensuring contextually relevant query generation. This query is then executed via the query executor 314, which interacts with the API layer 110 to fetch structured scene data from the graph database, spatial database, and/or dependency index. The response from these APIs provides the AI agent with retrieved spatial, semantic, or dependency-based relationships, allowing the AI agent to validate expected scene properties, refine missing relationships, or detect inconsistencies.

Per block 911, in response to the detecting of the first information associated with the scene by generating the first query, some embodiments automatically detect second information associated with the scene by generating, via the AI agent, a second query. In some embodiments, the generation of at least the first query and the second query (and/or associated responses) represent automatically generating a plurality of queries in a continuous loop until a threshold of at least one of spatial, semantic, or dependency-based information associated with the scene is met.

For example, the AI agent generates spatial queries in a continuous loop by leveraging spatial indexing structures (e.g., quad-trees or oct-trees) and proximity-based heuristics. The query planner and formulator 310 first issues an initial spatial query to determine object positions and distances (e.g., “What objects are within 3 meters of the lamp?”). The query executor 314 retrieves the data from the spatial database via the API layer 110, and the AI agent compares the results against expected spatial relationships using graph diff algorithms. If discrepancies or missing spatial properties (e.g., occlusions, containment relationships) are detected, the context manager triggers a follow-up spatial query, refining the query parameters (e.g., using adaptive bounding box resizing or hierarchical spatial searches) until a spatial completeness threshold is met.

For semantic queries, some embodiment iteratively refine functional and contextual object relationships by querying the graph database, which organizes scene elements as a node-edge graph. The AI agent first issues an initial semantic query (e.g., “Does the lamp illuminate the table?”). The query executor 314 fetches the relevant graph relationships using graph traversal algorithms (e.g., Breadth-First Search (BFS) or Depth-First Search (DFS)). If the expected illumination relationship is missing, the context manager 318 dynamically triggers a follow-up query to validate potential missing connections (e.g., “Is there an obstruction between the lamp and the table?”). This process continues, iterating through semantic refinements until the semantic completeness threshold (e.g., all expected object interactions are validated, functional roles are fully established, and/or no unresolved contextual dependencies remain) is reached, ensuring a comprehensive understanding of object functions and roles in the scene.

For dependency-based queries, some embodiments iterate through hierarchical scene relationships and cross-scene references using the dependency index. The AI agent issues an initial dependency query (e.g., “Is this door used in multiple scene configurations?”), retrieving results via directed graph traversal (e.g., topological sorting or transitive closure algorithms). If inconsistencies or unresolved dependencies are detected (e.g., a door has different positions across scenes), the query planner and formulator 310 dynamically generates a refinement query to cross-validate object references across multiple scenes. This process loops until the dependency completeness threshold (e.g., all referenced objects across scenes are consistently positioned, hierarchical parent-child relationships are fully resolved, and/or no conflicting dependencies exist between linked assets or scene configurations) is met, ensuring that all hierarchical relationships are correctly indexed and no cross-scene conflicts remain.

Based at least on the first information and the second information, some embodiments detect a gap in scene understanding of the scene. And based at least on the detecting of the gap, some embodiments trigger a follow-up query to detect additional information associated with the scene. Some embodiments detect one or more gaps in scene understanding by comparing the retrieved first and second information against expected spatial, semantic, and/or dependency relationships using graph diff algorithms (e.g., Graph Edit Distance, Structural Similarity Index) and/or uncertainty-based classification (e.g., entropy-based confidence scoring in neural networks). If a discrepancy or missing relationship is found, the context manager 318 dynamically triggers a follow-up query using (e.g., reinforcement) learning-based query optimization (e.g., Multi-Armed Bandit or Q-Learning for query prioritization) to iteratively refine scene comprehension until a completeness threshold is met.

In some embodiments, the second query is generated in response to detecting a change in the scene based at least on monitoring the scene in near real-time and updating the indexed scene data. For example, some embodiments use state tracking algorithms (e.g., event-driven change detection, scene differencing via hash-based comparisons, or temporal graph updates). When a modification is detected (e.g., an object is moved, removed, or added by a user), the scene update detector 116 triggers an event that updates the indexing system 108. In some embodiments, the context manager 318 then analyzes the impact of this change using graph diff algorithms (e.g., Graph Edit Distance for structural changes, Spatial KD-Tree Updates for geometric shifts) and determines whether any existing relationships have been invalidated or require refinement. If a missing or altered relationship is detected (e.g., a lamp previously illuminating a table is moved away), the query planner and formulator 310 generates a second query (e.g., “What is the new illumination coverage of the lamp?”) to retrieve updated scene properties and ensure scene consistency in near real-time.

Based at least on the generating of the plurality of queries and the threshold being met, some embodiments update the index with at least one of the spatial, semantic, or dependency-based information. Once the AI agent generates one or more queries (e.g., the plurality of queries) and determines that the spatial, semantic, and/or dependency completeness threshold has been met, the some embodiments update the indexing system 108 to ensure that the refined scene understanding is persistently stored. The query executor 314 retrieves the final resolved relationships from the spatial database, graph database, and/or dependency index, and the context manager 318 validates that no missing or conflicting data remains. In some embodiments, the system then applies indexing updates using incremental graph updates (e.g., adjacency list modifications for graph structures), spatial tree balancing (e.g., R-Tree or KD-Tree rebalancing for geometric data), and dependency resolution (e.g., topological sorting for hierarchical updates). For example, if the AI agent detects that a lamp illuminates a previously unindexed table, and follow-up queries confirm the relationship, the graph database is updated to store a new “illuminates” edge between the lamp node and the table node, ensuring future queries retrieve this refined scene information without reprocessing raw scene data.

Some embodiments execute a user (e.g., human issued) query based at least on accessing the updated index and matching one or more terms of the user query to one or more terms stored to the updated index. When a user issues a query, the AI agent orchestrates query execution by analyzing the query intent, retrieving relevant indexed scene data, and refining the results before presenting a response. The query planner and formulator 310 processes the user's input using natural language processing techniques (e.g., tokenization, named entity recognition with BERT, and sentence embedding retrieval via FAISS) to extract relevant spatial, semantic, or dependency-based terms in the query. The query executor 314 then matches these terms against the indexing system 108, using spatial proximity search (e.g., KD-Tree for geometric queries), graph traversal (e.g., Depth-First Search for semantic relationships), and/or dependency resolution (e.g., topological sorting for cross-scene references).

In an illustrative example, if a user asks, “Find all objects near the fire extinguisher within 2 meters,” the AI agent identifies “fire extinguisher” as a key entity (e.g., via Named Entity Recognition (NER)), retrieves its stored spatial properties from the spatial database, and formulates a structured spatial query. If the initial query response lacks contextual relationships (e.g., whether nearby objects obstruct access to the extinguisher), the context manager 318 detects this gap in scene understanding and triggers a follow-up query to the graph database to verify functional dependencies (e.g., “Is this extinguisher accessible?”). The response generator 316 then synthesizes the refined results into a structured answer, ensuring the user query is fully addressed with iterative scene reasoning.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models - such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more embodiments described below may be combined with one or more other embodiments. In an example embodiment, one or more processors comprise one or more processing units to: in response to an extraction of the scene data, index the scene data to cause the scene data to be queryable; based at least on the extraction of the scene data and the scene data being indexed, detect first information associated with the scene by generating a first query via an AI agent; and in response to the first query being generated, automatically detect second information associated with the scene by generating a second query via the AI agent.

In some embodiments, the scene data is extracted by at least one of: detecting an object in the scene via object detection, extracting a spatial property of the scene, extracting a visual property of the scene, extracting a natural language semantic label of the object in the scene, extracting an embedding that captures a property of the scene, or extracting one or more object-assigned data attributes.

In some embodiments, the scene data is extracted by extracting one or more object-assigned data attributes including at least one of: a physical property, a technical specification, an origin identifier, a value indicator, a reference to an external system, or dynamic data associated with the object from a real-time data source.

In some embodiments, the scene data in indexed by indexing the scene data into at least one of: a graph database storing objects as nodes and their relationships as edges, a spatial database storing geometric properties and spatial relationships of objects for spatial queries, or a dependency structure capturing dependency information between the scene and a second scene.

In some embodiments, the first information and the second information are detected based on receiving a response from one or more Application Programming Interfaces (APIs) that retrieve at least a portion of the scene data from at least one of the graph database, the spatial database, or the dependency structure.

In some embodiments, the AI agent generates the first query and the second query based at least on one of prompt engineering or tuning on example query-response pairs.

In some embodiments, the one or more processing units are further to: detect, based at least on the first information and the second information, a gap in scene understanding of the scene; and trigger, based at least on the gap being detected, a follow-up query to detect additional information associated with the scene.

In some embodiments, the second query is generated in response to detecting a change in the scene based at least on monitoring the scene and updating the indexed scene data.

In some embodiments, the one or more processing units are further to: generate, via the AI agent, at least a third query in a loop to detect at least one of spatial information, semantic information, or dependency-based information associated with the scene; and based at least on the generation of the third query in loop, update an index with the at least one of spatial information, semantic information, or dependency-based information.

In some embodiments, the one or more processing units are further to: execute a user query based at least on accessing the updated index and matching one or more terms of the user query to one or more terms stored to the updated index.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; a system incorporating one or more virtual machines (VMs); a system implemented at least partially in a data center; or a system implemented at least partially using cloud computing resources.

In an embodiment, a data center system comprises a plurality of computing nodes, wherein two or more computing nodes of the plurality of computing nodes comprises one or more graphics processing units (GPUs) to: obtain extracted scene data of a scene; store, in response to the obtaining of the extracted scene data, the extracted scene data using an index to cause the scene data to be queryable; based at least on the extracted scene data being obtained and stored using the index, automatically generate, via an AI agent, a plurality of queries until a threshold of at least one of spatial information, semantic information, or dependency-based information associated with the scene is met; and based at least on the generating of the plurality of queries and the threshold being met, update the index with at least one of the spatial information, semantic information, or dependency-based information.

In some embodiments, the one or more are further GPUs to: extract the scene data based at least on one of: detecting an object in the scene via object detection, extracting a spatial property of the scene, extracting a visual property of the scene, extracting a natural language semantic label of the object in the scene, extracting an embedding that captures a property of the scene, or extracting one or more object-assigned data attributes.

In some embodiments, the scene data is stored using an index by indexing the scene data into at least one of: a graph database storing objects as nodes and their relationships as edges, a spatial database storing geometric properties and spatial relationships of objects for spatial queries, or a dependency structure capturing dependency information between the scene and a second scene.

In some embodiments, the one or more GPUs are further to: detect first information and second information associated with the scene based on the AI agent generating the plurality of queries and based on receiving a response from one or more Application Programming Interfaces (APIs) that retrieve at least a portion of the scene data from at least one of the graph database, the spatial database, or the dependency structure.

In some embodiments, the AI agent generates the plurality of queries based at least on one of prompt engineering or tuning on example query-response pairs.

In some embodiments, the one or more GPUs are further to: detect, based at least on the generating of the plurality of queries, a gap in scene understanding of the scene; and trigger, based at least on the detecting of the gap, a follow-up query to detect additional information associated with the scene.

In some embodiments, at least one query of the plurality of queries is generated in response to detecting a change in the scene based at least on monitoring the scene and updating the indexed scene data.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; or a system incorporating one or more virtual machines (VMs).

In some embodiments, a method comprises: extracting scene data of a scene; detecting, based at least on the extracting the scene data, first information associated with the scene by generating a first query via an AI agent; and automatically detecting, in response to the detecting of at least one of the first information of the scene by generating the first query, second information associated with the scene by generating a second query via the AI agent.

What is claimed is:

1. One or more processors comprising one or more processing units to:
in response to an extraction of the scene data, index the scene data to cause the scene data to be queryable;
based at least on the extraction of the scene data and the scene data being indexed, detect first information associated with the scene by generating a first query via an AI agent; and
in response to the first query being generated, automatically detect second information associated with the scene by generating a second query via the AI agent.

2. The one or more processors of claim 1, wherein the scene data is extracted by at least one of: detecting an object in the scene via object detection, extracting a spatial property of the scene, extracting a visual property of the scene, extracting a natural language semantic label of the object in the scene, extracting an embedding that captures a property of the scene, or extracting one or more object-assigned data attributes.

3. The one or more processors of claim 2, wherein the scene data is extracted by extracting one or more object-assigned data attributes including at least one of: a physical property, a technical specification, an origin identifier, a value indicator, a reference to an external system, or dynamic data associated with the object from a real-time data source.

4. The one or more processors of claim 1, wherein the scene data in indexed by indexing the scene data into at least one of: a graph database storing objects as nodes and their relationships as edges, a spatial database storing geometric properties and spatial relationships of objects for spatial queries, or a dependency structure capturing dependency information between the scene and a second scene.

5. The one or more processors of claim 4, wherein the first information and the second information are detected based on receiving a response from one or more Application Programming Interfaces (APIs) that retrieve at least a portion of the scene data from at least one of the graph database, the spatial database, or the dependency structure.

6. The one or more processors of claim 1, wherein the AI agent generates the first query and the second query based at least on one of prompt engineering or tuning on example query-response pairs.

7. The one or more processors of claim 1, wherein the one or more processing units are further to:
detect, based at least on the first information and the second information, a gap in scene understanding of the scene; and
trigger, based at least on the gap being detected, a follow-up query to detect additional information associated with the scene.

8. The one or more processors of claim 1, wherein the second query is generated in response to detecting a change in the scene based at least on monitoring the scene and updating the indexed scene data.

9. The one or more processors of claim 1, wherein the one or more processing units are further to:
generate, via the AI agent, at least a third query in a loop to detect at least one of spatial information, semantic information, or dependency-based information associated with the scene; and
based at least on the generation of the third query in loop, update an index with the at least one of spatial information, semantic information, or dependency-based information.

10. The one or more processors of claim 8, wherein the one or more processing units are further to:
execute a user query based at least on accessing the updated index and matching one or more terms of the user query to one or more terms stored to the updated index.

11. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models;
a system incorporating one or more virtual machines (VMs);
a system implemented at least partially in a data center; or
a system implemented at least partially using cloud computing resources.

12. A data center system comprising a plurality of computing nodes, wherein two or more computing nodes of the plurality of computing nodes comprises one or more graphics processing units (GPUs) to:
obtain extracted scene data of a scene;
store, in response to the obtaining of the extracted scene data, the extracted scene data using an index to cause the scene data to be queryable;
based at least on the extracted scene data being obtained and stored using the index, automatically generate, via an AI agent, a plurality of queries until a threshold of at least one of spatial information, semantic information, or dependency-based information associated with the scene is met; and
based at least on the generating of the plurality of queries and the threshold being met, update the index with at least one of the spatial information, semantic information, or dependency-based information.

13. The data center of claim 12, wherein the one or more are further GPUs to: extract the scene data based at least on one of: detecting an object in the scene via object detection, extracting a spatial property of the scene, extracting a visual property of the scene, extracting a natural language semantic label of the object in the scene, extracting an embedding that captures a property of the scene, or extracting one or more object-assigned data attributes.

14. The data center of claim 12, wherein the scene data is stored using an index by indexing the scene data into at least one of: a graph database storing objects as nodes and their relationships as edges, a spatial database storing geometric properties and spatial relationships of objects for spatial queries, or a dependency structure capturing dependency information between the scene and a second scene.

15. The data center of claim 14, wherein the one or more GPUs are further to:
detect first information and second information associated with the scene based on the AI agent generating the plurality of queries and based on receiving a response from one or more Application Programming Interfaces (APIs) that retrieve at least a portion of the scene data from at least one of the graph database, the spatial database, or the dependency structure.

16. The data center of claim 12, wherein the AI agent generates the plurality of queries based at least on one of prompt engineering or tuning on example query-response pairs.

17. The data center of claim 12, wherein the one or more GPUs are further to:
detect, based at least on the generating of the plurality of queries, a gap in scene understanding of the scene; and
trigger, based at least on the detecting of the gap, a follow-up query to detect additional information associated with the scene.

18. The data center of claim 12, wherein at least one query of the plurality of queries is generated in response to detecting a change in the scene based at least on monitoring the scene and updating the indexed scene data.

19. The data center system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models; or
a system incorporating one or more virtual machines (VMs).

20. A method comprising:
extracting scene data of a scene;
detecting, based at least on the extracting the scene data, first information associated with the scene by generating a first query via an AI agent; and
automatically detecting, in response to the detecting of at least one of the first information of the scene by generating the first query, second information associated with the scene by generating a second query via the AI agent.
